(19) United States
(12) Patent Application Publication
(10) Pub. No.: US 2013/0117035 A1
(43) Pub. Date: May 9, 2013

(54) MEDICAL PAYMENT SYSTEM WITH DELAYED SETTLEMENT

(71) Applicants: Mark Tierney, Minneapolis, MN (US); Craig Servin, St. Bonifacius, MN (US); Timothy Hruska, Maple Grove, MN (US)

(72) Inventors: Mark Tierney, Minneapolis, MN (US); Craig Servin, St. Bonifacius, MN (US); Timothy Hruska, Maple Grove, MN (US)

(73) Assignee: MPAY GATEWAY, INC., Minneapolis, MN (US)

(21) Appl. No.: 13/481,276

(22) Filed: May 25, 2012

Related U.S. Application Data
(63) Continuation of application No. 12/235,276, filed on Sep. 22, 2008, now abandoned.
(60) Provisional application No. 60/974,329, filed on Sep. 21, 2007.

(51) Int. Cl. G06F 19/00

(52) U.S. Cl. CPC G06F 19/328
USPC 705/2

(57) ABSTRACT

Medical professionals may obtain payment authorization from their patients, even before the insurance company or other payer has determined the patient's ultimate financial obligation. In particular, the medical professional or their administrative staff may estimate the patient's financial obligations, obtain authorization for payment, and then subsequently collect payment at a later date once the actual financial obligation has been determined.

### PRIORITY

This application is a continuation of U.S. application Ser. No. 12/235,276, filed Sep. 22, 2008, which claims priority under 35 U.S.C. sctn. 119 to provisional application entitled “MEDICAL PAYMENT SYSTEM WITH DELAYED SETTLEMENT”, filed Sep. 21, 2007, with Ser. No. 60/974,329. This application is herein incorporated by reference in its entirety.

### TECHNICAL FIELD

The present disclosure pertains generally to medical payment systems and more particularly to medical payment systems that facilitate delayed settlement.

### BACKGROUND

Rising healthcare costs are an increasingly important issue, and a variety of different changes have been proposed or implemented in an attempt to control healthcare costs. One such change involves consumer-driven healthcare coverage. In many cases, this type of healthcare coverage involves a high deductible insurance plan, oftentimes coupled with a health savings account (HSA). Money that is contributed to the HSA may be pre-tax and can be used to cover medical and related expenses that are not otherwise covered by the high deductible insurance plan. In theory, an individual may be more careful in spending “their” money, rather than an insurance company's money.

Oftentimes, medical expenses incurred by an individual or a person for whom they are responsible are owed outright by the individual until a particular deductible has been satisfied for the year. Many times, the medical expense is not paid right away at the physician's office, but rather is paid at a later date once the corresponding paperwork has been processed by the physician's business office and subsequently by the insurance company. Even in cases where the insurance company has no financial obligation, such as when the expense is not covered or if the expense was incurred prior to satisfying the deductible, the insurance company will handle the paperwork in order to apply any discounts, update progress towards meeting the deductible, and the like.

Because of the time delays inherent in this system, the medical professional is left to bill the individual long after the individual has left the doctor's office. As a result, the medical professional incurs additional expenses pertaining to billing and collections. Moreover, many patients fail to pay their medical bills, either because they are unable to or perhaps because they are simply unwilling to. In either event, the end result is that the medical professional often incurs greater expenses and losses as a result of consumer-driven healthcare.

Participation in consumer-driven healthcare is expected to increase over time. Medical professionals have a need therefore, for a way to improve their ability to collect appropriate fees from their patients. A need remains for a way for medical professionals to obtain payment authorization from their patients, even before the insurance company or other payer has processed a particular claim and determined the patient's financial obligation.

### SUMMARY

The disclosure relates generally to medical payment systems and more particularly to medical payment systems that facilitate settlement with a patient. In one illustrative embodiment, medical professionals may obtain payment authorization from their patients, even before the insurance company or other payer has determined the patient's ultimate financial obligation. In some cases, a medical professional or their administrative staff may estimate the patient's financial obligations, obtain authorization for a future payment and/or receive payment or partial payment for the estimated financial obligation, and then subsequently collect fees from the patient at a later date in accordance with the previously-obtained authorization once the actual financial obligation has been determined. The medical professional or their staff may, in some instances, reconcile any difference between any advance payment received from the patient and the actual financial obligation of the patient.

An illustrative but non-limiting example of the disclosure may be found in a system for obtaining a point-of-sale authorization for a delayed settlement. The illustrative system includes a controller and a number of modules that are implemented by the controller. In some cases, the controller may be a stand alone controller, a computer system such as a personal computer or workstation, a server or any other suitable controller as desired. An identification module is implemented by the controller and is configured to accept data pertaining to a patient. An estimation module is implemented by the controller and is configured to obtain or determine an estimate of a financial obligation resulting from a medical encounter with the patient. An authorization module is implemented by the controller and is configured to accept an electronic authorization for payment of at least a portion of the estimated financial obligation. In some cases, the electronic authorization may be used to immediately obtain payment of the estimated financial obligation or a portion thereof, while in other cases, the electronic authorization may be held open until the actual financial obligation of the patient is determined.

The controller may also implement an output module that is configured to output information that pertains to the medical encounter. In some cases, the output module may communicate with a third party such as an insurance company, but this is not required. An input module may be implemented by the controller and may be configured to receive information pertaining to an actual financial obligation for the medical encounter. In some instances, the input module may receive information from a third party such as an insurance company or other payer, but this is not required. A settlement module may also be implemented by the controller and may be configured to settle the financial obligation using the previously obtained electronic authorization. In some case, such as when no advance payment has been made by the patient, the entire actual financial obligation of the medical encounter may be obtained using the previously obtained electronic authorization. In other cases, such as when some or all of the estimated financial obligation was already obtained, the settlement module may reconcile the previously received payment with the actual financial obligation and either draw or credit funds as necessary in accordance with the previously obtained electronic authorization to settle the financial obligation.

Another illustrative but non-limiting example of the disclosure may be found in a system for obtaining point-of-sale authorization for a delayed settlement. The system may include an identification module that is configured to identify a patient as well as an estimation module that is configured to estimate a financial obligation that results (or will result) from a medical encounter with the patient. An authorization module is configured to obtain an electronic authorization from the patient. A settlement module is configured to subsequently settle the financial obligation via the electronic authorization previously obtained.

Another illustrative but non-limiting example of the disclosure may be found in a method of obtaining point-of-sale authorization for a delayed settlement. An individual is identified, and a financial obligation result from a professional encounter with the individual is estimated. An electronic authorization is obtained from the individual. An insurance company may be contacted to determine an actual financial obligation, and then the actual financial obligation may subsequently be settled via the previously obtained electronic authorization. In some cases, the financial obligation may be settled by charging a credit or debit card used by the patient in providing the electronic authorization, and the estimated financial obligation may be used to predict and set the authorization limit of the electronic authorization, but this is not required.

The above summary is not intended to describe each and every disclosed embodiment or every implementation of the disclosure. The Description that follows more particularly exemplifies various illustrative embodiments.

### BRIEF DESCRIPTION OF THE FIGURES

The disclosure may be more completely understood in consideration of the following detailed description of various embodiments in connection with the accompanying drawings, in which:

FIG. 1 is a schematic view of an illustrative but non-limiting example of a system for obtaining point-of-sale authorization for a delayed settlement;

FIG. 2 is a schematic view of an illustrative but non-limiting example of a system for obtaining point-of-sale authorization for a delayed settlement;

FIGS. 3 through 7 provide flow diagrams showing illustrative but non-limiting examples of methods that may be carried out using the systems of FIG. 1 and/or FIG. 2; and

FIGS. 8 through 32 are screen captures showing portions of an illustrative but non-limiting user interface that may be implemented by the systems of FIGS. 1 and 2.

While the invention is amenable to various modifications and alternative forms, specifics thereof have been shown by way of example in the drawings and will be described in detail. It should be understood, however, that the intention is not to limit aspects of the invention to the particular embodiments described. On the contrary, the intention is to cover all modifications, equivalents, and alternatives falling within the spirit and scope of the invention.

### DESCRIPTION

The following description should be read with reference to the drawings in which similar elements in different drawings are numbered the same. The description and the drawings, which are not necessarily to scale, depict illustrative embodiments and are not intended to limit the scope of the invention. The illustrative embodiments depicted are intended only as exemplary. Selected features of any illustrative embodiment may be incorporated into other or additional embodiment unless clearly stated to the contrary.

The disclosure pertains generally to a medical payment system that permits various combinations of both immediate and delayed settlement of all or a portion of a payment owed to a health care provider. In some instances, the medical payment system permits a healthcare provider to obtain an authorization from a patient at the time of service. Once a claim resulting from the patient encounter has traversed the payer system and any insurance payments have been made and/or any plan-negotiated discounts have been applied, the healthcare provider is able to reconcile the remittance advice from the payer with the authorization previously obtained from the patient and determine the amount still owing the health care provider from the patient.

The medical payment system may include several components. In some cases, one component may be a point of sale terminal that permits a user to swipe a credit or debit card, similar to the point of sale terminals that some healthcare providers already have for processing payments from the patient. Additional components may be manifested in software. Non-limiting examples of these software-based components include an estimator, as will be described subsequently, as well as a component that provides an ability to place a temporary hold on a patient's card as well as capturing an open authorization on a payment settlement system (for an estimated responsibility) that may be settled days or weeks after the initial hold and authorization.

In some cases, the patient may checkout at the end of their visit, i.e., once the doctor or other healthcare provider has tended to the patient's needs and has created some sort of record, either electronic or on paper, that indicates which services have been performed and should be billed to the patient and/or the payer, i.e., the insurance company. In some instances, checkout may occur at the beginning of the visit, based upon the expected services to be performed. This may especially be practical when the expected services are well-defined, such as perhaps a wellness check, an appointment for a flu shot, perhaps an allergy shot, or any other pre-scheduled procedure and the like.

The information contained within the aforementioned record may be entered either electronically or manually into the medical payment system. In some cases, a doctor or other healthcare professional may physically make notes onto the patient's chart, and these notes may subsequently be manually entered into the illustrative medical payment system at or before checkout. In some instances, the doctor or other healthcare professional may enter their notes electronically into a computer, PDA or similar device while attending to the patient. The pertinent aspects of these electronic notes may be transferred electronically into the medical payment system.

In some cases, depending for example on the type of insurance carried by the patient, the medical payment system may estimate what the patient's responsibility will be once any insurance payments have been made and/or any plan-negotiated discounts have been applied. If a patient is fully insured, they may have a office visit copay that they are responsible for, and their insurance plan may cover everything else once discounts have been accounted for. The medical payment system may be configured to know these copay amounts and may permit the patient to pay the copay at checkout time using a payment card. Payments may for known price items, either pre-adjudicated or table driven, may be processed for patients on the medical payment system.

Conversely, if a person has a high deductible health care plan where the patient is responsible for all costs up to a certain limit, for example, the medical system may have access to information pertaining to the status of the patient's current plan year deductible, and may take the remaining deductible into account when estimating the patient's responsibility. In some cases a patient may be responsible for a portion of the charges for the services rendered (co-insurance). The payment systems may take into account the co-insurance payable by the patient.

In some instances, the illustrative medical payment system may include an estimator. The estimator may be manifested in software and/or hardware, and may be used to estimate the patient's responsibility once copays, insurance, deductibles, discounts and the like are accounted for. In some cases, the estimator may provide a list of services, and a user may enter discounted estimates for each service. In some instances, the estimator may be more sophisticated and may, for example, be programmed with a list of possible services and a price for each service. The price for each service may be the “rack rate”, or the full price charged for each service. The estimator may have access to information pertaining to the plan-negotiated discounts for a particular patient, and may use this information to estimate the patient's ultimate responsibility once these discounts have been applied by the payer. The estimator may calculate the appropriate charges based on some other method as proscribed by the health care provider's contract with a third party payer, a governmental agency, or by law or regulation. The estimator may also account for whether or not the patient has a remaining deductible to satisfy, for example.

In some ways, the checkout process employing the medical payment system may entail only a few simple, easy steps, once the patient has been identified or located within the system. During step 1, the healthcare provider may build an invoice, i.e., using the estimator to determine an estimated value for the patient's responsibility. At step 2, payment is initiated, i.e., a patient payment card is swiped for authorization and/or payment. The patient payment card may be any branded payment card such as Visa®, Mastercard®, American Express®, Discover®, or a card issued as part of the illustrative medical payment system. These cards may access funds within an HSA, an FSA, or an HRA. In some cases, these cards may simply be credit cards or they may be debit cards that access the patient's personal accounts. At step 3, the patient signs a receipt validating their commitment to pay. In some cases, unless the patient is paying a copay or other known price items, no amount may be charged against their card at this time. Instead, there is an authorization created and a hold placed for the estimated amount, although typically the hold expires after a period of several days and the authorization stays in effect much longer. In other cases, part or all of the estimated financial obligation estimated by the estimator may be drawn from the patient's card at checkout. After step 3, the patient portion of checkout is complete, and the patient is free to depart.

At step 4, the healthcare provider may prepare a claims submission to the payer as is commonly done now. Reconciliation and settlement occur at step 5, where the healthcare provider utilizes functionality of the illustrative medical payment system to reconcile the payer's remittance advice for the actual financial obligation of the patient against the charge authorization previously obtained at checkout. In some cases, a healthcare provider or an individual in an associated business office has the ability to compare the remittance advice against the charge authorization. If the remittance advice matches or almost matches the charge authorization (but does not exceed the charge authorization), the person reviewing the matter may decide to accept the remittance advice, and the patient's card will be charged that amount. If the remittance advice exceeds the charge authorization, the reviewing individual may decide to reduce the remittance advice to match the charge authorization, or the reviewing individual may interpret the discrepancy as indicating the presence of a potential error and they may then flag the matter for further review. In the parlance of the medical payment system, this may be considered an issue.

In some instances, the medical payment system may be configured to communicate with one or more components of a healthcare provider's business, including one or more of scheduling, billing, claims creation, accounts receivable, general ledger and the like. In some cases, the medical payment system may itself provide one or more of these functions. In some cases, the medical payment system may be in communication with one or more external functions or systems such as payers, financial networks, and the like.

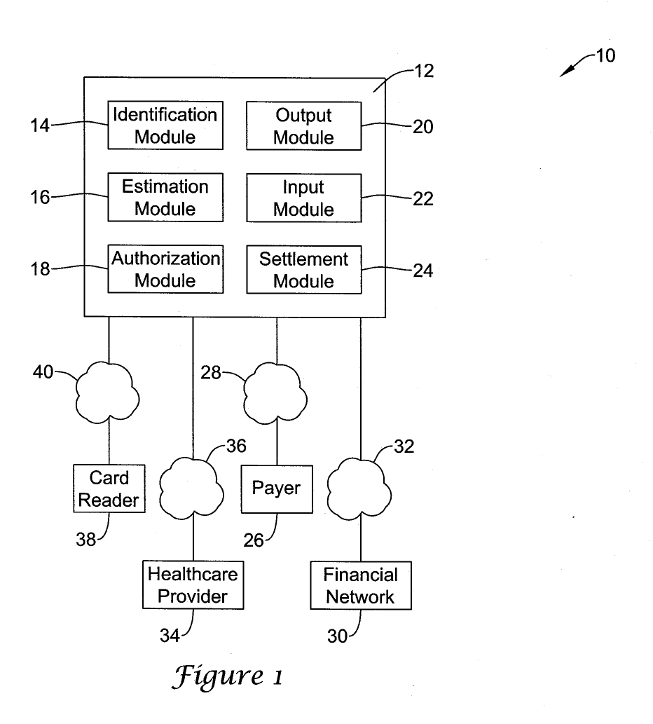

Turning now to the Figures, FIG. 1 is a schematic view of an illustrative but non-limiting system 10 that is configured to permit a provider such as a doctor, a dentist, a medical clinic, a hospital, a pharmacy and the like, either before or immediately after a medical encounter with a patient, to obtain authorization for a delayed settlement of a medical encounter.

System 10 includes a controller 12. It will be appreciated that controller 12 may represent a computer or a computer network that may be in communication with other system components. Controller 12 may include or otherwise provide a number of modules that may work together to provide the illustrative system described herein. Controller 12 may include one or more of an identification module 14, an estimation module 16, an authorization module 18, an output module 20, an input module 22 and a settlement module 24. Each of these modules, which may be manifested in hardware and/or software that is operated by controller 12, will be described in turn.

Identification module 14 may be used in identifying an individual such as a patient or perhaps a person financially responsible for the patient if the patient is a minor, for example. Identification module 14 may include or otherwise have access to information including the patient's name and address, details regarding their healthcare coverage, and the like. Identification module 14 may permit manual entry of at least some of the data pertaining to a particular patient. In some cases, identification module 14 may be configured to accept data transferred electronically from another database or software program. For example, identification module 14 may be able to receive data from the healthcare provider's scheduling software, the healthcare provider's computerized medical records, and the like. In some cases, identification module 14 may be used to select a particular patient from a pull-down menu or from a list of search results for subsequent processing.

Estimation module 16 may be used to estimate what a patient's financial obligation may be as a result of a medical encounter such as a doctor's visit, blood tests and the like. In some cases, estimation module 16 may be used after an encounter to estimate the patient's obligation for each of the treatments, tests and the like that were administered to the patient. In some cases, estimation module 16 may determine an estimated financial obligation that is based upon a rack rate, or full price, for each of the treatments and or tests. Estimation module 16 may adjust these prices in accordance with any discounts that may have been established on the patient's behalf by their insurance company or other payer, or any geographical discounts. In some cases, estimation module 16 may also factor in information pertaining to whether or not the patient has satisfied their current year's deductible, as well as any other suitable factor useful in estimating the financial obligation that might result from the medical encounter.

Once estimation module 16 has determined the estimated financial obligation, authorization module 18 may be used to obtain an electronic authorization from the patient. The electronic authorization essentially permits the healthcare provider to subsequently charge a credit card, a debit card, an HSA card or the like for an amount up to the estimated financial obligation. In some cases, the electronic authorization may be used to immediately obtain payment of the estimated financial obligation or a portion thereof, while in other cases, the electronic authorization may be held open until the controller 12 has received information pertaining to an actual financial obligation that represents what the patient actually owes once the insurance company or other payer has factored in any discounts, deductibles and the like. Obtaining the electronic authorization may involve swiping the patient's credit card or debit card to obtain a hold and an authorization. While the hold on the funds may expire after several days, the authorization may remain open until settlement. The credit or debit card may be a bank card such as VISA® or MASTERCARD®, an HSA card, or the like. In some cases, it is contemplated that obtaining the electronic authorization may involve an ACH (automated clearing house) transaction instead be tied directly to a financial account such as a checking account or savings account that is held by the patient.

It will be appreciated that the term HSA, or health savings account, is used generically herein to refer to accounts that are designed for payment of medical expenses, and frequently are funded with pre-dollars. These accounts may be set up in accordance with the tax code and other federal and/or state regulations. In some cases, health savings accounts are known by other names, such as medical savings account (MSA), flexible spending accounts (FSA), health reimbursement accounts (HRA) and others.

After controller 12 has determined the estimated financial obligation and has obtained an electronic authorization granting permission to charge the patient's credit card accordingly, the output module 20 may be used to output information pertaining to the patient's medical encounter. This information may be used to determine the patient's actual financial obligation. In some cases, output module 20 may simply print or display information that can be entered into an appropriate database or software programming for forwarding to an insurance company or other payer or perhaps simply be mailed to the payer. In some instances, output module 20 may communicate directly (e.g. electronically) with the insurance company or other payer to provide the appropriate information.

Input module 22 may be used to receive information pertaining to the patient's actual financial obligation. In some cases, the healthcare provider may receive an EOB (Explanation of Benefits) from the insurance company or other payer. The EOB may be a printed document, and thus input module 22 may be configured to permit someone to manually enter the appropriate data from the FOB. In some cases, the EOB may be received electronically, and in these situations input module 22 may be configured to extract the appropriate data from the electronic EOB. Once input module 22 has received the information pertaining to the actual financial obligation of the patient, settlement module 24 may be used in settling the obligation. It will be appreciated that in some cases, data may be electronically retrieved from other data sources such as an Explanation of Payment (EOP) or other forms of electronic remittance advice records or documents defined under various industry standards, such as ANSI 835, and other data messages, such as data messages having estimated patient or health network payment information (e.g., prepared by a third party processor).

Settlement module 24 may be used to settle the financial obligation using the previously obtained electronic authorization. In some case, such as when no advance payment has been made by the patient, the entire actual financial obligation of the medical encounter may be obtained using the previously obtained electronic authorization. In other cases, such as when some or all of the estimated financial obligation was already obtained, the settlement module may reconcile the previously received payment with the actual financial obligation and either draw or credit funds as necessary in accordance with the previously obtained electronic authorization to settle the financial obligation.

In some cases, the actual financial obligation will match the estimated financial obligation, and settlement may be achieved by charging the patient's credit or debit card an amount equal to the previously-obtained electronic authorization. In some instances, the actual financial obligation may be slightly higher or slightly lower than the estimated financial obligation. Settlement module 24 may be programmed or configured to adjust the settlement amount accordingly. In some cases, settlement module 24 may permit an individual to review patient records manually, and thus may permit an individual to make the appropriate decisions pertaining to settlement.

If the actual amount is slightly greater than the estimated amount, settlement module 24 may truncate the actual amount to equal the estimated amount and may charge the patient's credit card or debit card for this amount. If the actual amount is slightly less than the estimated amount, settlement module 24 may adjust the financial obligation to match the lower amount and may charge the patient's card accordingly. In some cases, there may be a substantial difference between the actual and estimated amounts. In some instances, this may be an indication of an error, and these files may be automatically rejected or perhaps may be flagged for manual review.

It will be appreciated that controller 12 does not operate in a vacuum. Rather, system 10 may include additional components. A payer 26 such as an insurance company, health maintenance organization (HMO) and the like may be connected via a network 28 to controller 12. In some cases, network 28 may be a local area network (LAN), a wide area network (WAN) or even the Internet. In some instances, network 28 may simply represent a flow of data, either electronically or on paper, between controller 12 and payer 26. As noted above, output module 20 may send or otherwise provide to payer 26 information pertaining to a patient's medical encounter so that payer 26 may prepare an appropriate FOB or other document (electronic or otherwise) that provides input module 22 with information regarding an actual financial obligation.

Illustrative system 10 may also include a financial network 30 that may be connected via a network 32 to controller 12. In some cases, network 32 may be a local area network (LAN), a wide area network (WAN) or even the Internet. In some instances, network 32 may simply represent a flow of data, either electronically or on paper, between controller 12 and financial network 32. Financial network 32 may represent a single bank or card issuer, a conglomerate of banks, a banking system, and the like. It will be appreciated that financial network 32 may represent a number of interconnected financial networks, although for simplicity only a single network is shown. Financial network 32 may, for example, generically represent card issuers such as VISA® or MASTERCARD®.

It can be seen that illustrative system 10 also includes a healthcare provider 34 that may be connected to controller 12 via a network 36. In some cases, network 36 may be a local area network (LAN), a wide area network (WAN) or even the Internet. In some instances, network 36 may simply represent a flow of data, either electronically or on paper, between controller 12 and healthcare provider 34. It will be appreciated that healthcare provider 34 is not necessarily intended to refer to a person. Rather, healthcare provider 34 is intended to refer to a business entity such as a doctor's office, a medical billings department, a medical business office and the like.

Illustrative system 10 also includes an authorization input device such as a card reader 38 that communicates with controller 12 via a cable or network 40. In some cases, cable or network 40 may be a USB cable, a parallel port cable, a serial port cable, a Firewire cable, a local area network (LAN), a wide area network (WAN) or even the Internet. In some instances, cable or network 40 may simply represent a flow of data, either electronically or on paper, between controller 12 and card reader 38. It will be appreciated that although a card reader is schematically illustrated, other data entry devices are contemplated. Illustrative but non-limiting examples of other data entry devices include identification devices such as fingerprint or thumbprint readers, optical readers and the like.

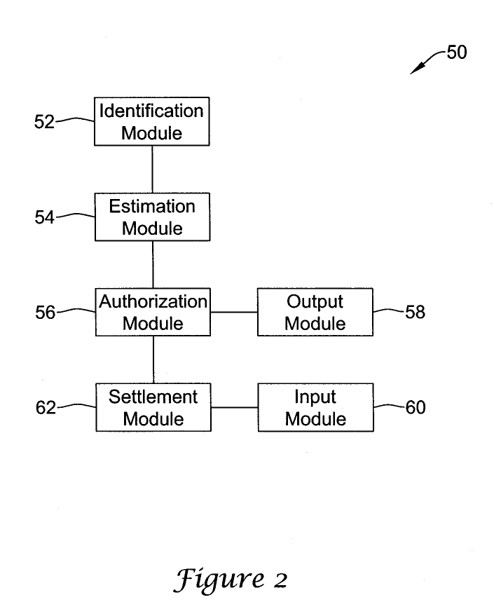

Turning now to FIG. 2, an illustrative system 50 is illustrated. In some instances, system 50 may be implemented in software, and may be considered as including a number of sub programs or modules that may each carry out particular functions. In some cases, system 50 may include one or more of an identification module 52, an estimation module 54, an authorization module 56, an output module 58, an input module 60 and a settlement module 62.

Identification module 52 may be used in identifying an individual such as a patient or perhaps a person financially responsible for the patient if the patient is a minor, for example. Identification module 52 may include or otherwise have access to information including the patient's name and address, details regarding their healthcare coverage, and the like. Identification module 52 may permit manual entry of at least some of the data pertaining to a particular patient. In some cases, identification module 52 may be configured to accept data transferred electronically from another database or software program as discussed above with respect to identification module 14 (FIG. 1).

Estimation module 54 may be used to estimate what a patient's financial obligation may be as a result of a medical encounter such as a doctor's visit, blood tests and the like. In some cases, estimation module 54 may determine an estimated financial obligation that is based upon a rack rate, or full price, for each of the treatments and or tests. Estimation module 54 may adjust these prices in accordance with any discounts that may have been established on the patient's behalf by their insurance company or other payer, or any geographical discounts. In some cases, estimation module 54 may also factor in information pertaining to whether or not the patient has satisfied their current year's deductible, as well as any other suitable factor useful in estimating the financial obligation that might result from the medical encounter.

Once estimation module 54 has determined the estimated financial obligation, authorization module 56 may be used to obtain an electronic authorization from the patient. The electronic authorization essentially permits the healthcare provider to subsequently charge a credit card, a debit card, an HSA card or the like for an amount up to the estimated financial obligation. In some cases, the electronic authorization may be used to immediately obtain payment of the estimated financial obligation or a portion thereof, while in other cases, the electronic authorization may be held open until the controller 12 has received information pertaining to an actual financial obligation that represents what the patient actually owes once the insurance company or other payer has factored in any discounts, deductibles and the like. Obtaining the electronic authorization may involve swiping the patient's credit card or debit card to obtain a hold and an authorization. While the hold on the funds may expire after several days, the authorization may remain open for a longer period of time in accordance with card network rules. In some instances, the authorization may remain open until settlement.

After system 50 has determined the estimated financial obligation and has obtained an electronic authorization granting permission to charge the patient's credit card accordingly, the output module 58 may be used to output information pertaining to the patient's medical encounter. This information may be used to determine the patient's actual financial obligation. In some cases, output module 58 may simply print or display information that can be entered into an appropriate database or software programming for forwarding to an insurance company or other payer or perhaps simply be mailed to the payer. In some instances, output module 58 may communicate directly (e.g. electronically) with the insurance company or other payer to provide the appropriate information.

Input module 60 may be used to receive information pertaining to the patient's actual financial obligation. In some cases, the healthcare provider may receive an EOB (Explanation of Benefits) from the insurance company or other payer. The EOB may be a printed document, and thus input module 60 may be configured to permit someone to manually enter the appropriate data from the EOB. In some cases, the FOB may be received electronically, and in these situations input module 60 may be configured to extract the appropriate data from the electronic EOB.

Once input module 60 has received the information pertaining to the actual financial obligation of the patient, settlement module 62 may be used in settling the obligation. It will be appreciated that in some cases, data may be electronically retrieved from other data sources such as an Explanation of Payment (EOP) or other forms of electronic remittance advice records or documents defined under various industry standards, such as ANSI 835, and other data messages, such as data messages having estimated patient or health network payment information (e.g., prepared by a third party processor).

Settlement module 62 may be used to settle the financial obligation using the previously obtained electronic authorization. In some case, such as when no advance payment has been made by the patient, the entire actual financial obligation of the medical encounter may be obtained using the previously obtained electronic authorization. In other cases, such as when some or all of the estimated financial obligation was already obtained, the settlement module may reconcile the previously received payment with the actual financial obligation and either draw or credit funds as necessary in accordance with the previously obtained electronic authorization to settle the financial obligation.

In some cases, the actual financial obligation will match the estimated financial obligation, and settlement may be achieved by charging the patient's credit or debit card an amount equal to the previously-obtained electronic authorization. In some instances, the actual financial obligation may be slightly higher or slightly lower than the estimated financial obligation. Settlement module 62 may be programmed or configured to adjust the settlement amount accordingly. In some cases, settlement module 62 may permit an individual to review patient records manually, and thus may permit an individual to make the appropriate decisions pertaining to settlement.

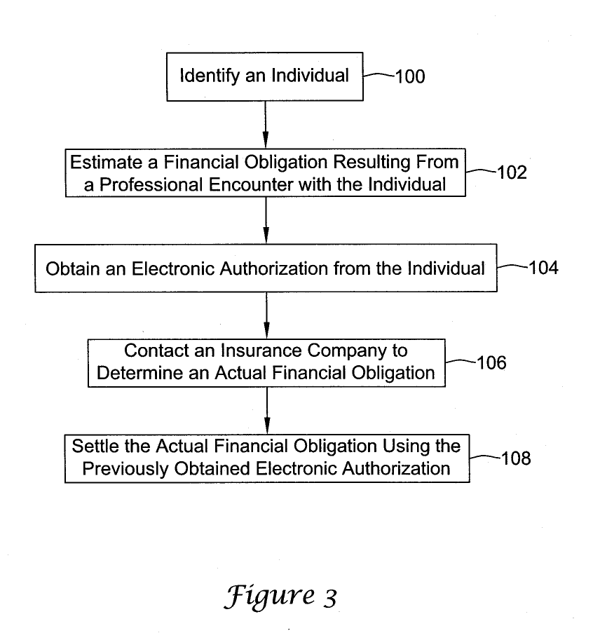

FIGS. 3 through 7 provide flow diagrams showing illustrative but non-limiting examples of methods that may be carried out using illustrative system 10 (FIG. 1) and/or illustrative system 50 (FIG. 2). It will be appreciated that in some instances, a single user may progress through each of the steps outlined in FIGS. 3 through 7. In some cases, a first user may progress through part of a step or one or more steps, then may pause the transaction. This may be referred to as pending the transaction. At a later point in time, the user may reopen the transaction right where they left off, and may continue. In some cases, it may be a second user that reopens the transaction and continues through the process.

In FIG. 3, control begins at block 100, where an individual is identified. In some cases, the individual may be a patient or a person that is financially responsible for a patient, particularly when the patient himself or herself is a minor. As discussed above, identifying an individual may involve manual data entry or electronically transferring and/or capturing data from an appropriate source. This may involve identifying a new patient, or pulling up an existing patient from a pull-down menu, search results list, and the like.

Control passes to block 102, where the system (such as system 10 of FIG. 1 and/or system 50 of FIG. 2) estimates a financial obligation resulting from a professional encounter with the individual. In some cases, this may occur prior to the encounter, particularly if the plans for the encounter are well defined. In some instances, estimation may occur after the encounter has occurred but before the individual has left the healthcare provider's offices. The estimation may be determined in a variety of ways. In some cases, an estimated amount may be manually entered while in other instances a software module or program may determine the estimate based upon one or more of the rack rate for a given procedure or visit, any predetermined or negotiated discounts, and the like.

At block 104, an electronic authorization is obtained. In some cases, the electronic authorization may be obtained for an amount that equals the estimated financial obligation determined or otherwise obtained at block 102. In some instances, the electronic authorization may be equal to the estimated financial obligation plus a particular or predetermined padding amount in order to reduce the chances that the actual financial obligation (subsequently determined by the insurance carrier or other payer) exceeds the authorization amount as this may otherwise require subsequently billing the patient for the difference or discounting the actual financial obligation to meet the authorization. In some cases, the authorization amount may be for less than the estimated amount, particularly if the patient's insurance carrier requires a copay and/or if the patient has a high deductible plan and the estimated amount fully satisfies the annual deductible. In some cases, and as described above, the electronic authorization may be used to immediately obtain payment of the estimated financial obligation or a portion thereof.

Control passes to block 106, where an insurance carrier or other payer is contacted in order to determine the actual financial obligation. In some cases, system 10 (FIG. 1) and/or system 50 (FIG. 2) may electronically transmit information pertaining to the patient encounter to the insurance carrier or other payer. In some cases, it is contemplated that the information may instead be printed and mailed to the insurance carrier or other payer, although electronic transfer may be faster and/or more cost effective.

Once the insurance carrier or other payer provides system 10 (or system 50) with the actual financial obligation, which as discussed above may be determined using one or more of a number of factors, control passes to block 108, where the actual financial obligation is settled using the previously obtained electronic authorization. In some case, such as when no advance payment has been made by the patient, the entire actual financial obligation of the medical encounter may be obtained using the previously obtained electronic authorization. In other cases, such as when some or all of the estimated financial obligation was already obtained, block 108 may reconcile the previously received payment with the actual financial obligation and either draw or credit funds as necessary in accordance with the previously obtained electronic authorization to settle the financial obligation. As discussed above, settlement may involve making small adjustments to the actual financial obligation in order to fit within the electronic authorization.

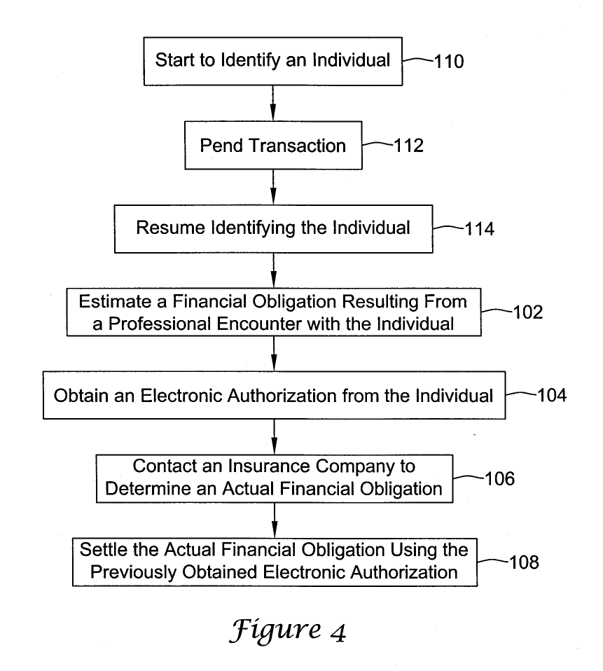

In FIG. 4, control begins at block 110, where a process of identifying an individual is started. In some cases, for example, an office employee may pull up and/or enter any and all patient information for a particular time period before the patients will arrive at the healthcare provider. Not only may this save time during the patient encounter, but this may also provide cost savings as a single person may be employed to enter a substantial amount of data pertaining to a number of patients. This person may even be offsite.

Control passes to block 112, where a person doing the data entry or otherwise identifying the patient may pend the transaction. This means that system 10 (FIG. 1) and/or system 50 (FIG. 2) may permit the person to exit a patient identification screen so that they can proceed to other activities, seeing to patients, and the like. In some cases, system 10 and/or system 50 may return to an exact exit point when resuming the transaction at block 114.

Control passes to block 102, where the system (such as system 10 of FIG. 1 and/or system 50 of FIG. 2) estimates a financial obligation resulting from a professional encounter with the individual. In some cases, this may occur prior to the encounter, particularly if the plans for the encounter are well defined. In some instances, estimation may occur after the encounter has occurred but before the individual has left the healthcare provider's offices. The estimation may be determined in a variety of ways. In some cases, an estimated amount may be manually entered while in other instances a software module or program may determine the estimate based upon one or more of the rack rate for a given procedure or visit, any predetermined or negotiated discounts, and the like.

At block 104, an electronic authorization is obtained. In some cases, the electronic authorization may be obtained for an amount that equals the estimated financial obligation determined or otherwise obtained at block 102. In some instances, the electronic authorization may be equal to the estimated financial obligation plus a particular or predetermined padding amount in order to reduce the chances that the actual financial obligation (subsequently determined by the insurance carrier or other payer) exceeds the authorization amount as this may otherwise require subsequently billing the patient for the difference or discounting the actual financial obligation to meet the authorization. In some cases, the authorization amount may be for less than the estimated amount, particularly if the patient's insurance carrier requires a copay and/or if the patient has a high deductible plan and the estimated amount fully satisfies the annual deductible. In some cases, and as described above, the electronic authorization may be used to immediately obtain payment of the estimated financial obligation or a portion thereof.

Control passes to block 106, where an insurance carrier or other payer is contacted in order to determine the actual financial obligation. In some cases, system 10 (FIG. 1) and/or system 50 (FIG. 2) may electronically transmit information pertaining to the patient encounter to the insurance carrier or other payer. In some cases, it is contemplated that the information may instead be printed and mailed to the insurance carrier or other payer, although electronic transfer may be faster and/or more cost effective.

Once the insurance carrier or other payer provides system 10 (or system 50) with the actual financial obligation, which as discussed above may be determined using one or more of a number of factors, control passes to block 108, where the actual financial obligation is settled using the previously obtained electronic authorization. In some case, such as when no advance payment has been made by the patient, the entire actual financial obligation of the medical encounter may be obtained using the previously obtained electronic authorization. In other cases, such as when some or all of the estimated financial obligation was already obtained, block 108 may reconcile the previously received payment with the actual financial obligation and either draw or credit funds as necessary in accordance with the previously obtained electronic authorization to settle the financial obligation. As discussed above, settlement may involve making small adjustments to the actual financial obligation in order to fit within the electronic authorization.

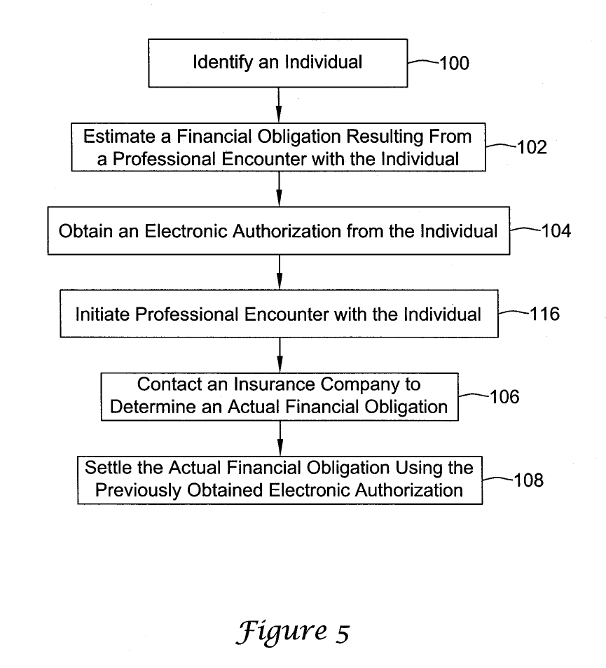

In FIG. 5, control begins at block 100, where an individual is identified. In some cases, the individual may be a patient or a person that is financially responsible for a patient, particularly when the patient himself or herself is a minor As discussed above, identifying an individual may involve manual data entry or electronically transferring and/or capturing data from an appropriate source. This may involve identifying a new patient, or pulling up an existing patient from a pull-down menu, search results list, and the like.

Control passes to block 102, where the system (such as system 10 of FIG. 1 and/or system 50 of FIG. 2) estimates a financial obligation resulting from a professional encounter with the individual. The estimation may be determined in a variety of ways. In some cases, an estimated amount may be manually entered while in other instances a software module or program may determine the estimate based upon one or more of the rack rate for a given procedure or visit, any predetermined or negotiated discounts, and the like.

At block 104, an electronic authorization is obtained. In some cases, the electronic authorization may be obtained for an amount that equals the estimated financial obligation determined or otherwise obtained at block 102. In some instances, the electronic authorization may be equal to the estimated financial obligation plus a particular or predetermined padding amount in order to reduce the chances that the actual financial obligation (subsequently determined by the insurance carrier or other payer) exceeds the authorization amount as this may otherwise require subsequently billing the patient for the difference or discounting the actual financial obligation to meet the authorization. In some cases, the authorization amount may be for less than the estimated amount, particularly if the patient's insurance carrier requires a copay and/or if the patient has a high deductible plan and the estimated amount fully satisfies the annual deductible. In some cases, and as described above, the electronic authorization may be used to immediately obtain payment of the estimated financial obligation or a portion thereof.

After the authorization has been obtained at block 104, a professional encounter with the individual may commence, as indicated at block 116. In this situation, it is assumed that the patient's financial obligation can be readily and accurately estimated prior to the patient seeing the doctor or other health professional. This may occur, for example, if the planned encounter is well-defined, such as a general office visit, a wellness check, blood work, a flue shot, and the like. After or before the encounter has ended, control passes to block 106, where an insurance carrier or other payer is contacted in order to determine the actual financial obligation. In some cases, system 10 (FIG. 1) and/or system 50 (FIG. 2) may electronically transmit information pertaining to the patient encounter to the insurance carrier or other payer. In some cases, it is contemplated that the information may instead be printed and mailed to the insurance carrier or other payer, although electronic transfer may be faster and/or more cost effective.

Once the insurance carrier or other payer provides system 10 (or system 50) with the actual financial obligation, which as discussed above may be determined using one or more of a number of factors, control passes to block 108, where the actual financial obligation is settled using the previously obtained electronic authorization. In some case, such as when no advance payment has been made by the patient, the entire actual financial obligation of the medical encounter may be obtained using the previously obtained electronic authorization. In other cases, such as when some or all of the estimated financial obligation was already obtained, block 108 may reconcile the previously received payment with the actual financial obligation and either draw or credit funds as necessary in accordance with the previously obtained electronic authorization to settle the financial obligation. As discussed above, settlement may involve making small adjustments to the actual financial obligation in order to fit within the electronic authorization.

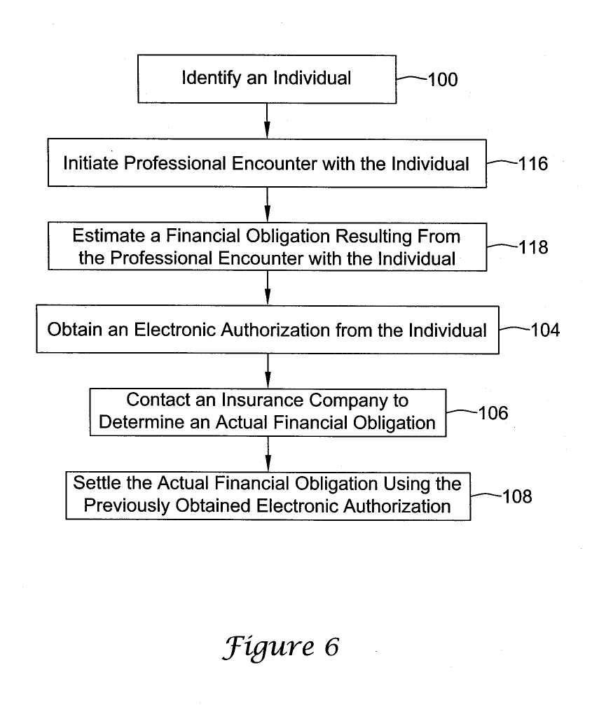

In FIG. 6, control begins at block 100, where an individual is identified. In some cases, the individual may be a patient or a person that is financially responsible for a patient, particularly when the patient himself or herself is a minor. As discussed above, identifying an individual may involve manual data entry or electronically transferring and/or capturing data from an appropriate source. This may involve identifying a new patient, or pulling up an existing patient from a pull-down menu, search results list, and the like.

At block 116, a professional encounter with the individual may commence. In this situation, the patient sees the healthcare provider prior to the steps of estimating the financial obligation or obtaining an appropriate electronic authorization. In some situations, there may not be a well-defined plan for the encounter, i.e., the doctor or other professional does not know how much time they may need to spend with the patient, or which tests may be needed, or the like. This way, a more accurate estimate may be obtained by waiting until after the encounter has ended and there is a documented record of what transpired.

Control passes to block 118, where the system (such as system 10 of FIG. 1 and/or system 50 of FIG. 2) estimates a financial obligation resulting from the professional encounter with the individual. The estimation may be determined in a variety of ways. In some cases, an estimated amount may be manually entered while in other instances a software module or program may determine the estimate based upon one or more of the rack rate for a given procedure or visit, any predetermined or negotiated discounts, and the like.

At block 104, an electronic authorization is obtained. In some cases, the electronic authorization may be obtained for an amount that equals the estimated financial obligation determined or otherwise obtained at block 102. In some instances, the electronic authorization may be equal to the estimated financial obligation plus a particular or predetermined padding amount in order to reduce the chances that the actual financial obligation (subsequently determined by the insurance carrier or other payer) exceeds the authorization amount as this may otherwise require subsequently billing the patient for the difference or discounting the actual financial obligation to meet the authorization. In some cases, the authorization amount may be for less than the estimated amount, particularly if the patient's insurance carrier requires a copay and/or if the patient has a high deductible plan and the estimated amount fully satisfies the annual deductible. In some cases, and as described above, the electronic authorization may be used to immediately obtain payment of the estimated financial obligation or a portion thereof.

Control passes to block 106, where an insurance carrier or other payer is contacted in order to determine the actual financial obligation. In some cases, system 10 (FIG. 1) and/or system 50 (FIG. 2) may electronically transmit information pertaining to the patient encounter to the insurance carrier or other payer. In some cases, it is contemplated that the information may instead be printed and mailed to the insurance carrier or other payer, although electronic transfer may be faster and/or more cost effective.

Once the insurance carrier or other payer provides system 10 (or system 50) with the actual financial obligation, which as discussed above may be determined using one or more of a number of factors, control passes to block 108, where the actual financial obligation is settled using the previously obtained electronic authorization. In some case, such as when no advance payment has been made by the patient, the entire actual financial obligation of the medical encounter may be obtained using the previously obtained electronic authorization. In other cases, such as when some or all of the estimated financial obligation was already obtained, block 108 may reconcile the previously received payment with the actual financial obligation and either draw or credit funds as necessary in accordance with the previously obtained electronic authorization to settle the financial obligation. As discussed above, settlement may involve making small adjustments to the actual financial obligation in order to fit within the electronic authorization.

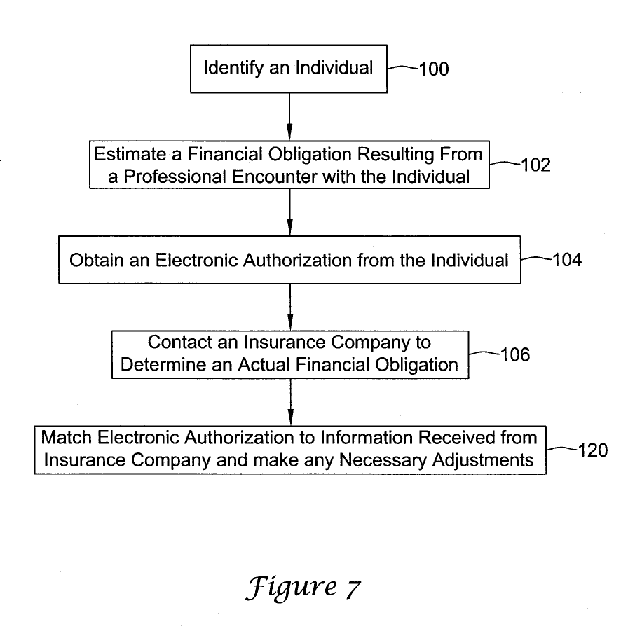

In FIG. 7, control begins at block 100, where an individual is identified. In some cases, the individual may be a patient or a person that is financially responsible for a patient, particularly when the patient himself or herself is a minor. As discussed above, identifying an individual may involve manual data entry or electronically transferring and/or capturing data from an appropriate source. This may involve identifying a new patient, or pulling up an existing patient from a pull-down menu, search results list, and the like.

Control passes to block 102, where the system (such as system 10 of FIG. 1 and/or system 50 of FIG. 2) estimates a financial obligation resulting from a professional encounter with the individual. In some cases, this may occur prior to the encounter, particularly if the plans for the encounter are well defined. In some instances, estimation may occur after the encounter has occurred but before the individual has left the healthcare provider's offices. The estimation may be determined in a variety of ways. In some cases, an estimated amount may be manually entered while in other instances a software module or program may determine the estimate based upon one or more of the rack rate for a given procedure or visit, any predetermined or negotiated discounts, and the like.

At block 104, an electronic authorization is obtained. In some cases, the electronic authorization may be obtained for an amount that equals the estimated financial obligation determined or otherwise obtained at block 102. In some instances, the electronic authorization may be equal to the estimated financial obligation plus a particular or predetermined padding amount in order to reduce the chances that the actual financial obligation (subsequently determined by the insurance carrier or other payer) exceeds the authorization amount as this may otherwise require subsequently billing the patient for the difference or discounting the actual financial obligation to meet the authorization. In some cases, the authorization amount may be for less than the estimated amount, particularly if the patient's insurance carrier requires a copay and/or if the patient has a high deductible plan and the estimated amount fully satisfies the annual deductible. In some cases, and as described above, the electronic authorization may be used to immediately obtain payment of the estimated financial obligation or a portion thereof.

Control passes to block 106, where an insurance carrier or other payer is contacted in order to determine the actual financial obligation. In some cases, system 10 (FIG. 1) and/or system 50 (FIG. 2) may electronically transmit information pertaining to the patient encounter to the insurance carrier or other payer. In some cases, it is contemplated that the information may instead be printed and mailed to the insurance carrier or other payer, although electronic transfer may be faster and/or more cost effective.

Once the insurance carrier or other payer provides system 10 (or system 50) with the actual financial obligation, which as discussed above may be determined using one or more of a number of factors, control passes to block 120, where the actual financial obligation is matched or compared with the previously obtained electronic authorization. In some case, such as when no advance payment has been made by the patient, the entire actual financial obligation of the medical encounter may be matched with the previously obtained electronic authorization. In other cases, such as when some or all of the estimated financial obligation was already obtained, block 120 may match or compare the previously received payment with the actual financial obligation. In either case, any necessary adjustments may be made so that the amount actually charged to the patient's credit card or debit card does not exceed the electronic authorization.

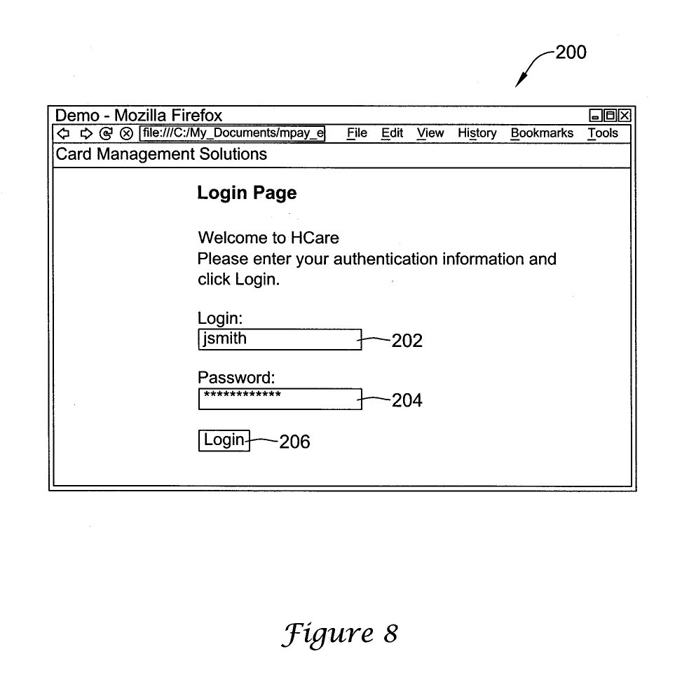

FIGS. 8 through 32 provide an illustrative but non-limiting look at a user interface that may be manifested by illustrative system 10 (FIG. 1) and/or by illustrative system 50 (FIG. 2). While the screen captures shown in these Figures appear to be web pages, it will be appreciated that the illustrative user interface does not have to be displayed via a thin client such as a web browser, but can be equally tailored to display on a single computer or on several computers connected, for example, to a local or wide area network.

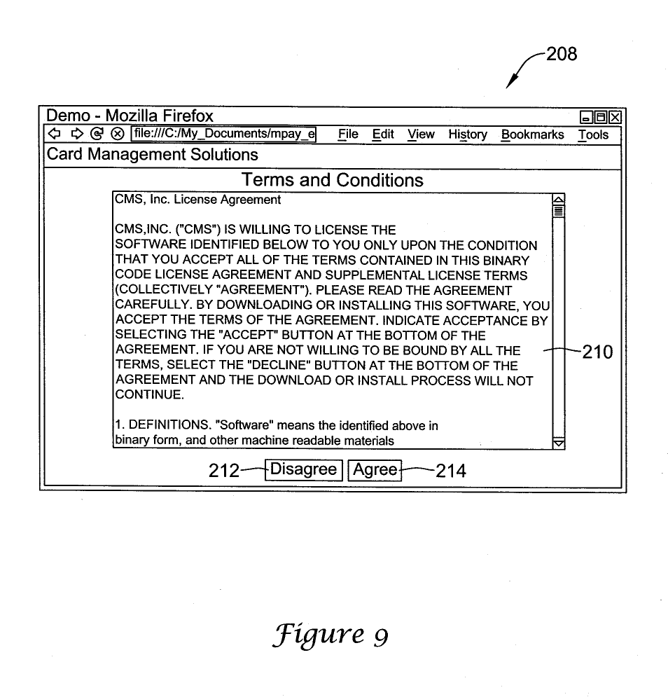

FIG. 8 provides an illustrative login screen 200 that may be displayed by illustrative system 10 (or system 50). Login screen 200 may, for example, include a username box 202, a password box 204 and a login button 206. In some cases, login screen 200 may include further information such as login instructions, a morning welcome greeting, clip art, and the like, although this is not required. An individual may click on login button 206 after they have entered an appropriate username and password. In some cases, clicking on login button 206 may cause a screen 208 (shown in FIG. 9) to be displayed. Referring to FIG. 9, illustrative screen 208 includes a text box 210 that includes information pertaining to a license agreement. In some cases, screen 208 may not be displayed. If displayed, screen 208 may include a disagree button 210 and an agree button 212. Pressing agree button 212 may cause system 10 (or system 50) to progress to a subsequent screen while pressing disagree button 210 may cause system 10 (or system 50) to revert to the login screen.

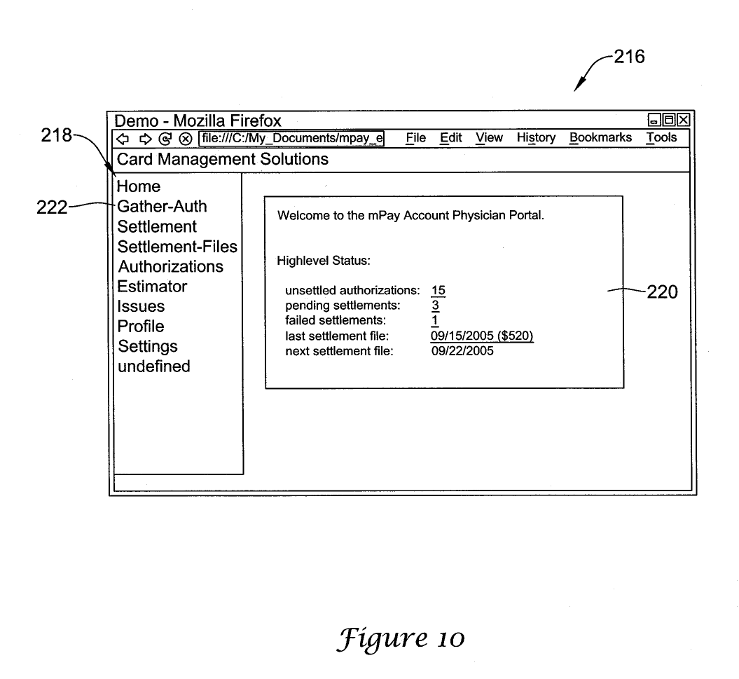

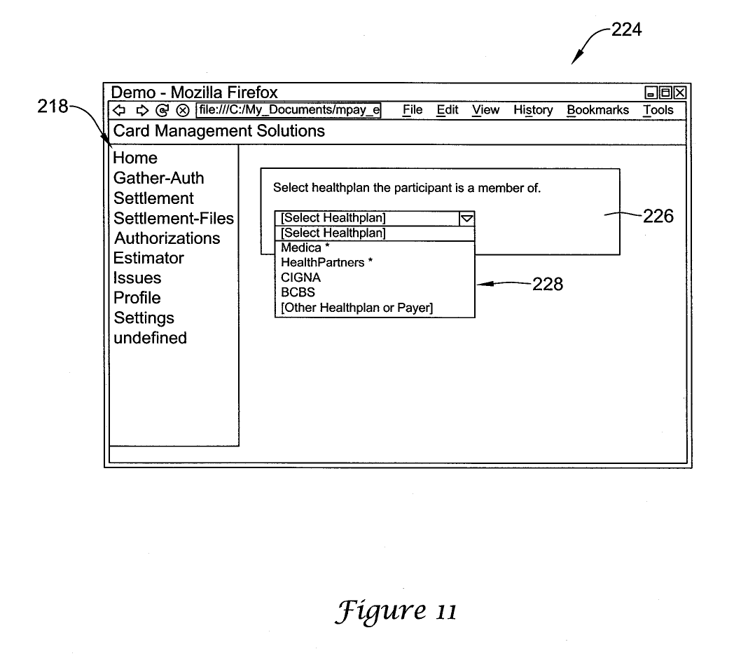

In some instances, pressing agree button 212 may cause system 10 (or system 50) to display a screen 216, as seen in FIG. 10. Referring to FIG. 10, illustrative screen 216 may be seen as including a top level menu 218. Screen 216 also includes a text box 220 that may, for example, provide a user with an overview of system status, a reminder of unfinished entries and the like. Top level menu 218 includes a number of clickable links including a “Gather-Auth” link 222. This link, which may of course have other names such as “Begin patient encounter” or the like may, if clicked, cause system 10 (or system 50) to display a screen 224 as seen in FIG. 11.

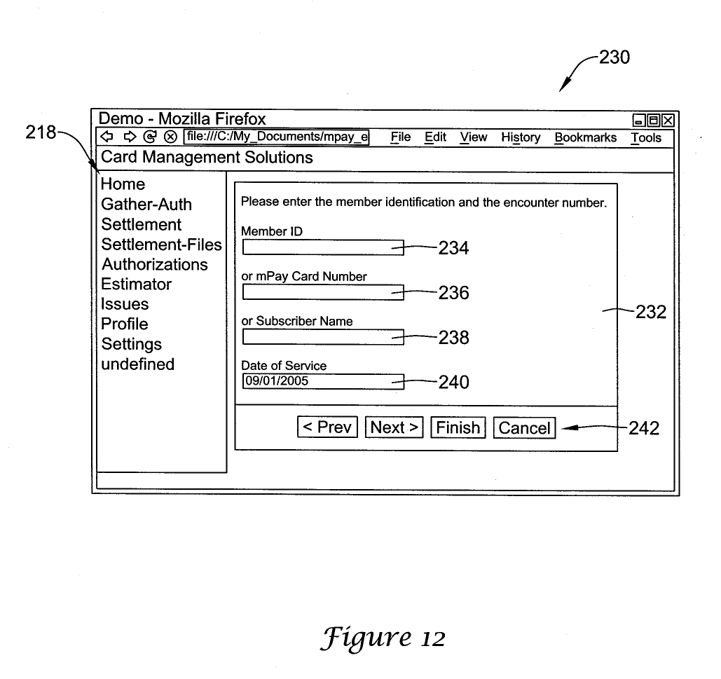

Turning to FIG. 11, illustrative screen 224 may permit a user to begin the process of identifying a patient. Screen 224 includes a text box 226 that instructs the user to select the health plan that a particular patient belongs or subscribes to. In the illustrative screen capture, text box 226 includes a pull-down menu 228 by which the user may select the appropriate health plan. In some cases, text box 226 may instead include an empty box into which the user may type the name of an appropriate health plan, although this option is not expressly illustrated in this screen. After the health plan has been selected, system 10 (or system 50) may display a screen 230 as seen in FIG. 12.

In FIG. 12, illustrative screen 230 permits a user to enter identifying information pertaining to a patient. In some cases, screen 230 may instead be integrated with screen 224 (FIG. 11). In some instances, screen 230 may be split into two or more screens if desired. As illustrated, screen 230 includes a text box 232 that may include one or more of a member ID box 234, a membership card box 236 or a subscriber name box 238 that may be used to identify the patient. A date box 240 permits the user to enter the date of service. This data entry may, for example, take place before, during or after the actual date of service. Screen 230 may also include a navigational bar 242 that may be used to move laterally within the user interface.

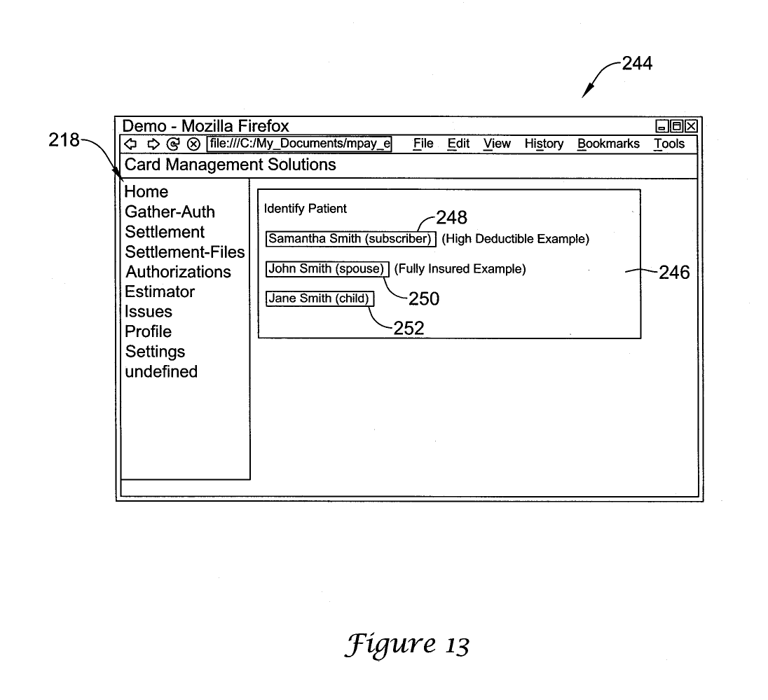

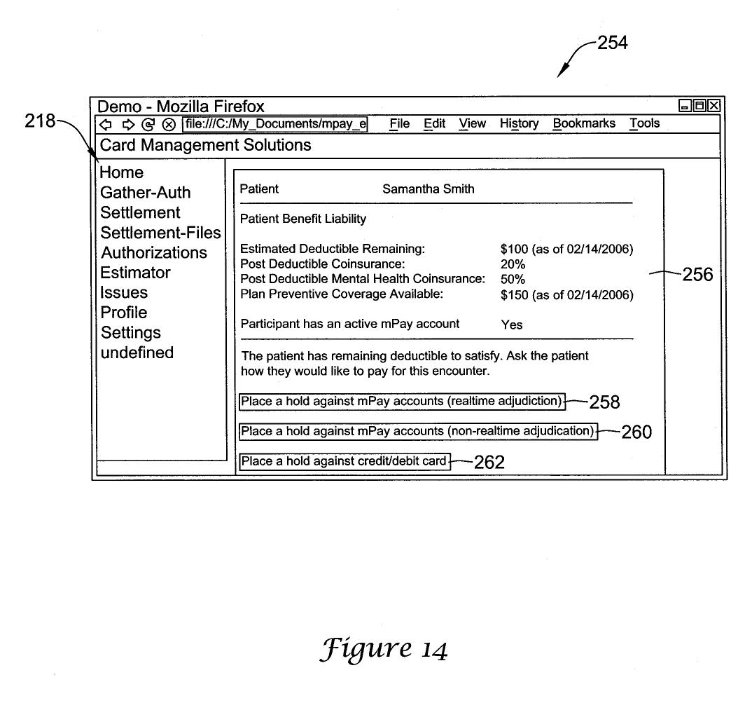

In some cases, illustrative system 10 (or system 50) may display a list of patients for the user to choose from. FIG. 13 provides a screen 244 that includes a text box 246 including a list of patients. In the illustrated display, text box 246 includes a box 248 showing a high deductible patient, a box 250 showing a fully insured patient and a box 252 showing a dependent. In the illustrated display, only one patient is shown in each box. It will be appreciated, however, that one or more of box 248, box 250 or box 252 may instead be pull-down menus or similar display constructs showing a plurality of patients for the user to select from. If the user clicks on box 248, selecting the patient named “Samantha Smith”, system 10 (or system 50) may display a screen 254, as seen in FIG. 14.

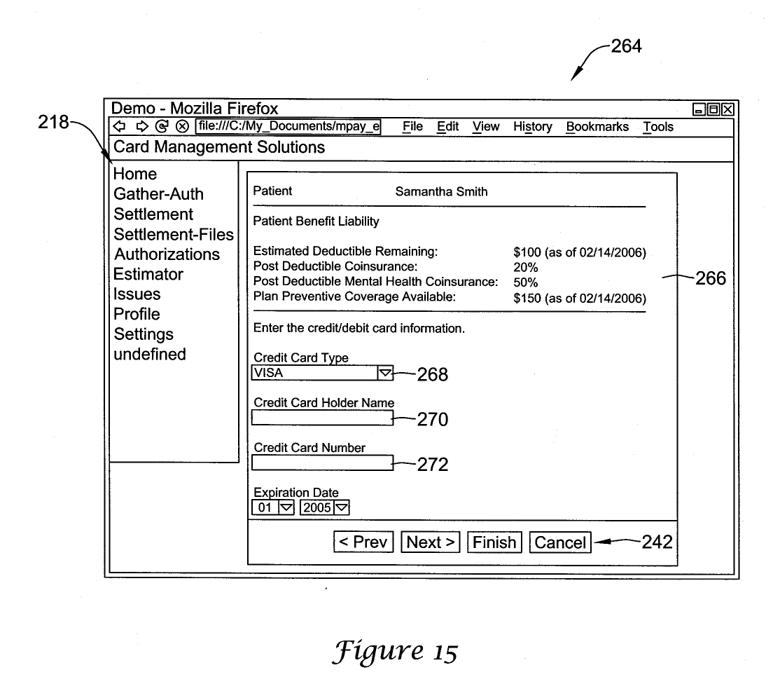

Referring to FIG. 14, illustrative screen 254 includes a text box 256 that provides information pertaining to the patient's insurance coverage, remaining deductibles and the like. In the illustrated example, the patient has not yet satisfied their deductible. Text box 256 permits the user to tell system 10 (or system 50) how the patient wishes to pay their portion of the medical expense. In some cases, the patient may elect to place a hold on their subscription account as seen in box 258 and box 260. In some instances, the patient may elect to use their credit or debit card. For illustrative purposes, it can be assumed that the patient has elected to use their credit or debit card. Clicking on a box 262 may cause system 10 (or system 50) to display a screen 264, as seen in FIG. 15.

With reference to FIG. 15, illustrative screen 264 includes a text box 266 that once again summarizes the patient's insurance situation. Text box 266 also permits entry of credit card information. Accordingly, text box 266 may include one or more of a credit card type box 268, a credit card holder name box 270 and a credit card number box 272. In some cases, this information may be manually entered. In some instances, at least some of this information may be captured electronically by swiping the patient's credit card. In some cases, some health insurance providers or other entities may provide health insurance cards that include a bar code, magnetic strip or other source of encoded data. When so provided, it is contemplated that the patient identification information may be collected and input into the system by simply scanning the bar code or swiping the card.

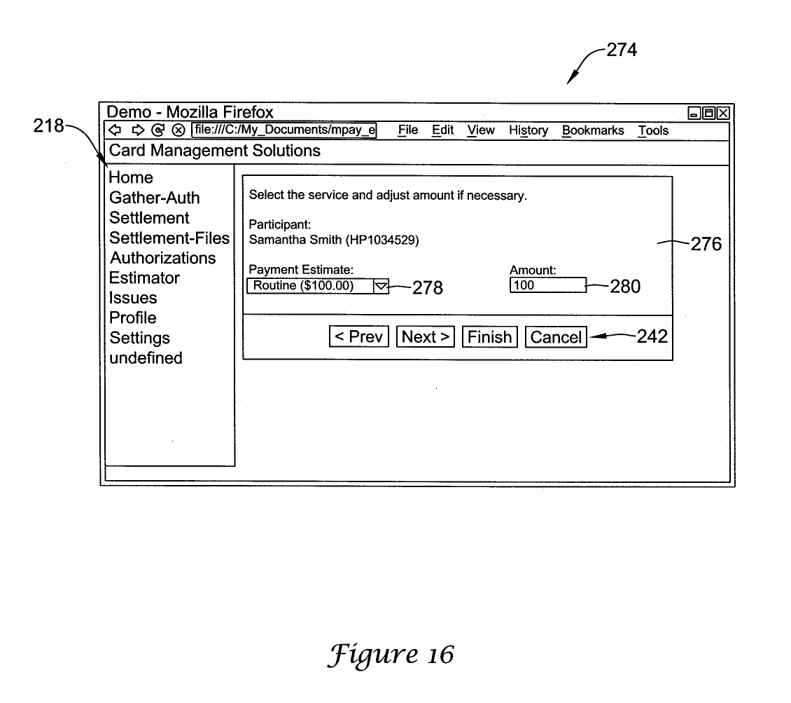

After the credit card information has been entered or captured, the user may use navigation bar 242 to move to a subsequent screen such as screen 274, seen in FIG. 16. Screen 274 permits the user to enter information pertaining to what service or services the patient will or has already received for a particular date. Screen 274 includes a text box 276 that identifies the patient and instructs the user to enter each service. Text box 276 may include a pull-down menu 278 that permits the user to select from a list of possible services. A box 280 displays an estimated cost for whichever service or services are selected via pull-down menu 278. In some cases, box 280 may display an estimated cost that is calculated or otherwise obtained by system 10 (or system 50). In some instances, system 10 (or system 50) may permit the user to manually enter a dollar amount into box 280, or even to override if necessary the estimated cost displayed by system 10 (or system 50).

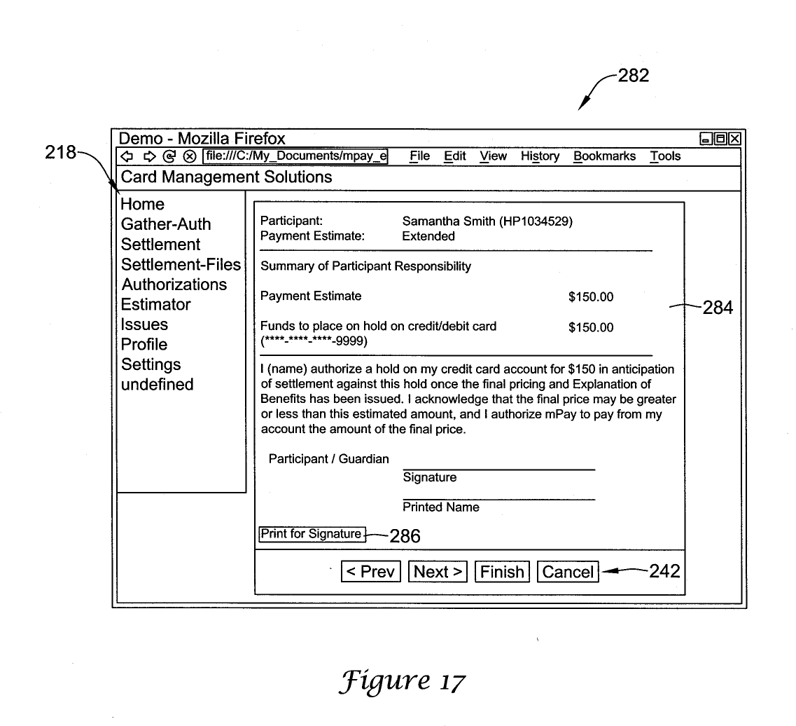

In the illustrated display, only a single service has been selected. It will be appreciated, however, that there are circumstances in which a number of different services will have been selected. For example, perhaps the patient has seen (or is about to see) the doctor to have a wart removed, have a mole inspected and receive a tetanus shot. This may result in four distinct charges, for each of the three distinct services as well as for an office visit. Once the service or services have been selected, the user may progress to a subsequent screen using navigation bar 242. In some cases, the user may progress to a screen 282, as seen in FIG. 17.

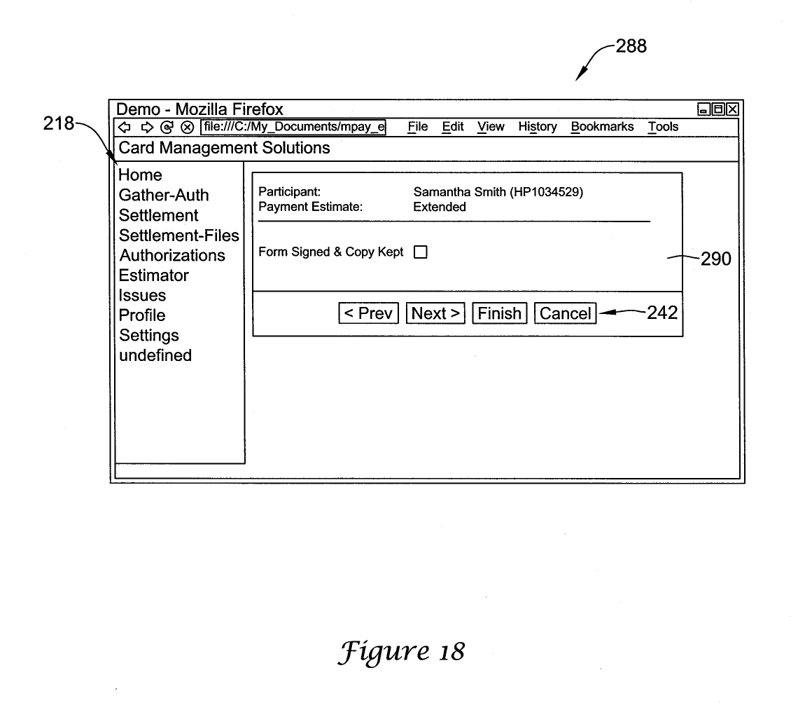

In FIG. 17, the authorization process has begun. Screen 282 includes a text box 284 that provides a summary of the patient's estimated financial obligation as well as a place for the patient to sign in order to confirm their commitment to honor the debt. A print for signature box 286 may cause system 10 (or system 50) to print text box 284 so that the patient can sign. In some cases, it is contemplated that system 10 (or system 50) may instead capture an electronic signature from the patient. In either case, system 10 (or system 50) may display a screen 288, seen in FIG. 18, that includes a text box 290 that has a check box 292 that, if checked, confirms to the system that the patient has signed the agreement.

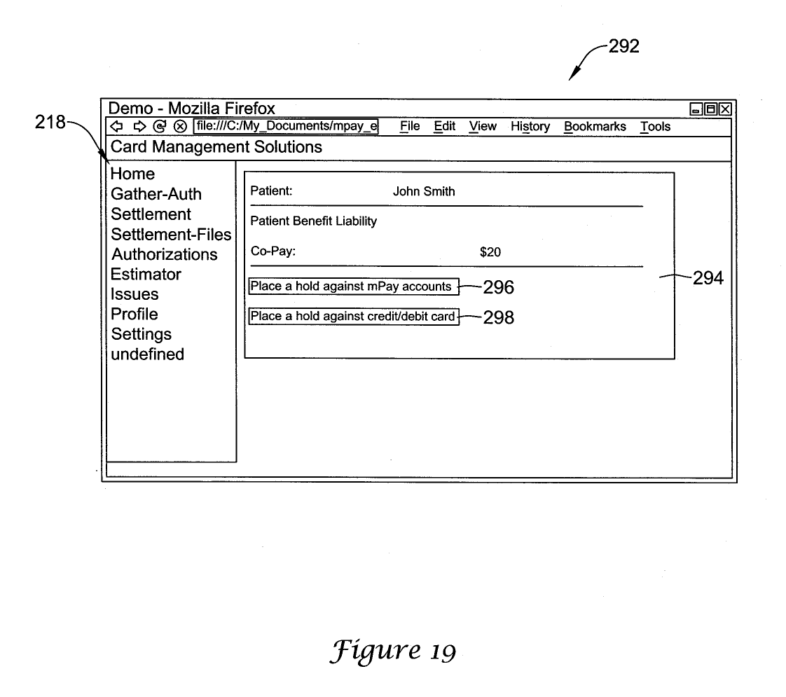

Returning briefly to FIG. 13, the following screen captures illustrate selection of a fully insured individual as listed in box 250. In this particular example, system 10 (or system 50) has determined that “John Smith” is fully insured, and that he has a $20 copay. Payment of the copay is believed to fully satisfy his obligation, and thus no estimate is necessary. FIG. 19 shows a screen 292 that includes a text box 294. Text box 294 includes information identifying the patient as well as his financial obligation. Text box 294 also provides options for the patient to satisfy their financial obligation. In this example, text box 294 includes a box 296 that permits the patient to charge to their subscription account and a box 298 that permits the patient to use their credit card or their debit card. In this example, the patient elects to use their credit or debit card.

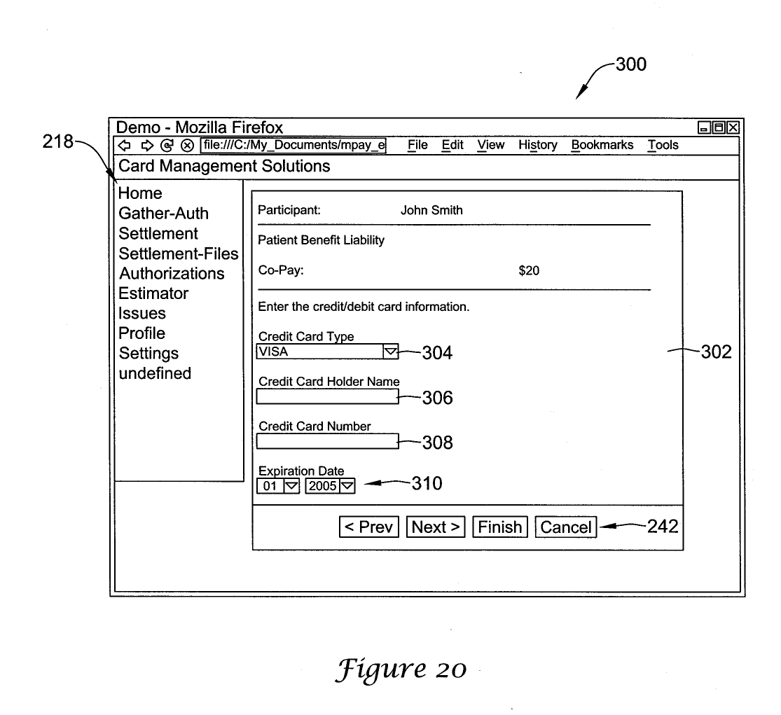

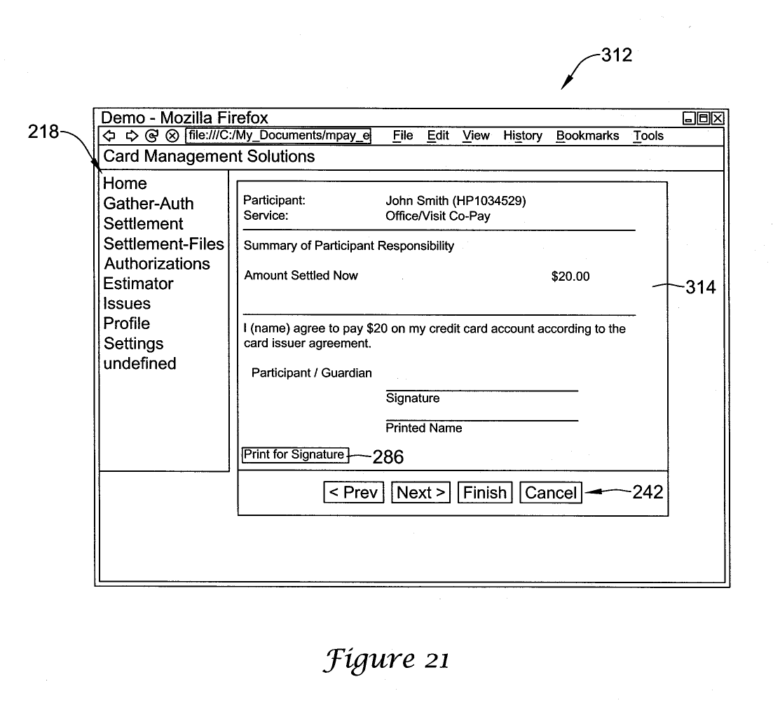

FIG. 20 provides a screen 300 that includes a text box 302. Text box 302 displays information confirming the identity of the patient as well as their financial obligation. Text box 302 also permits entry of information pertaining to the patient’ credit card. Text box 302 may include a credit card type pull-down menu 304, a credit card holder name box 306, a credit card number box 308 and an expiration date pull-down menu 310. In some instances, this information may be entered manually while in other cases at least some of this information may be obtained electronically, either from the patient's records or by swiping their credit card. Once the information has been entered or otherwise obtained, the user may use navigation bar 242 to progress to a subsequent screen such as screen 312, seen in FIG. 21.

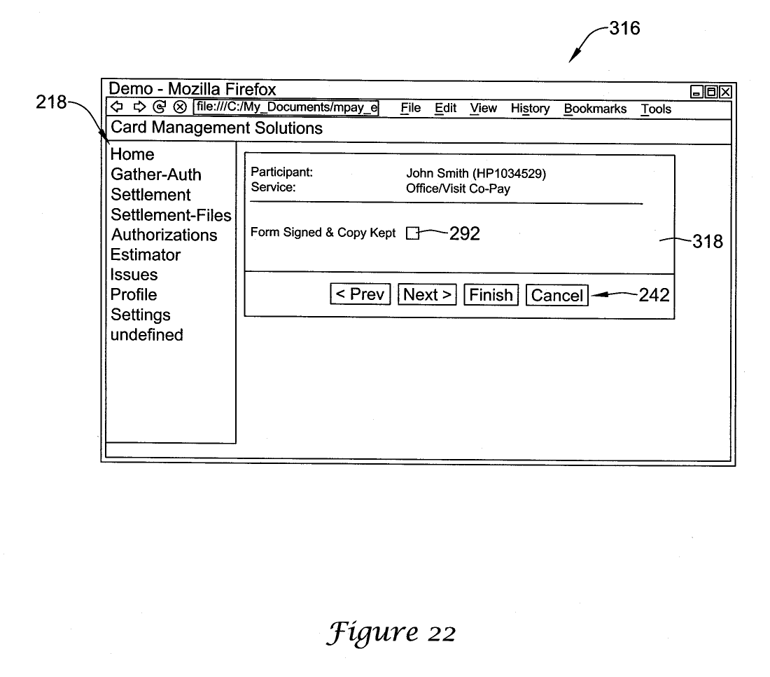

Turning to FIG. 21, screen 312 includes a text box 284 that provides a summary of the patient's estimated financial obligation as well as a place for the patient to sign in order to confirm their commitment to honor the debt. A print for signature box 286 may cause system 10 (or system 50) to print text box 284 so that the patient can sign. In some cases, it is contemplated that system 10 (or system 50) may instead capture an electronic signature from the patient. In either case, system 10 (or system 50) may display a screen 316, seen in FIG. 22, that includes a text box 290 that has a check box 292 that, if checked, confirms to the system that the patient has signed the agreement.

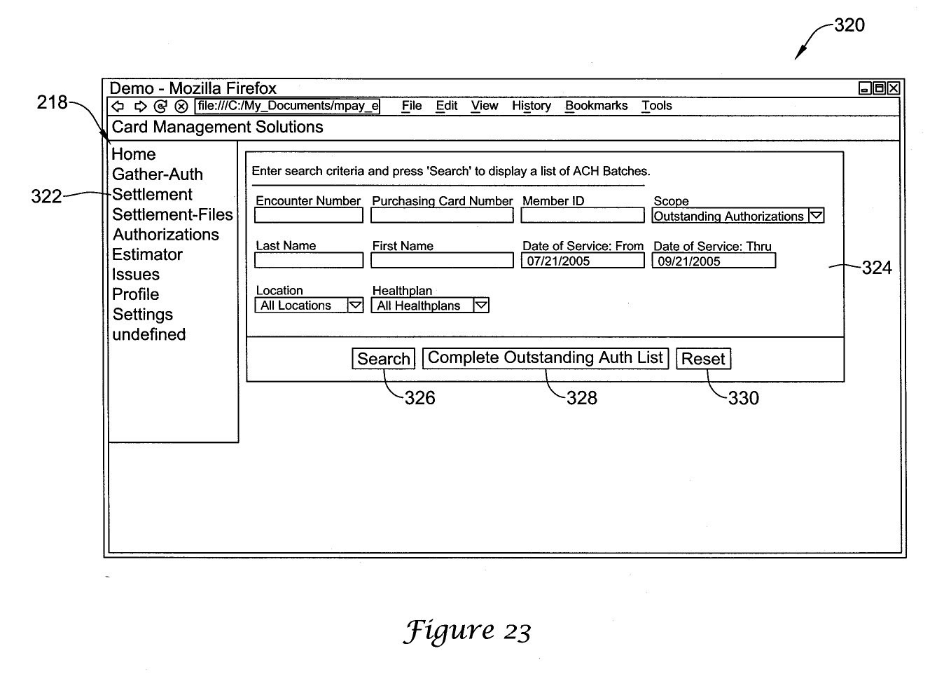

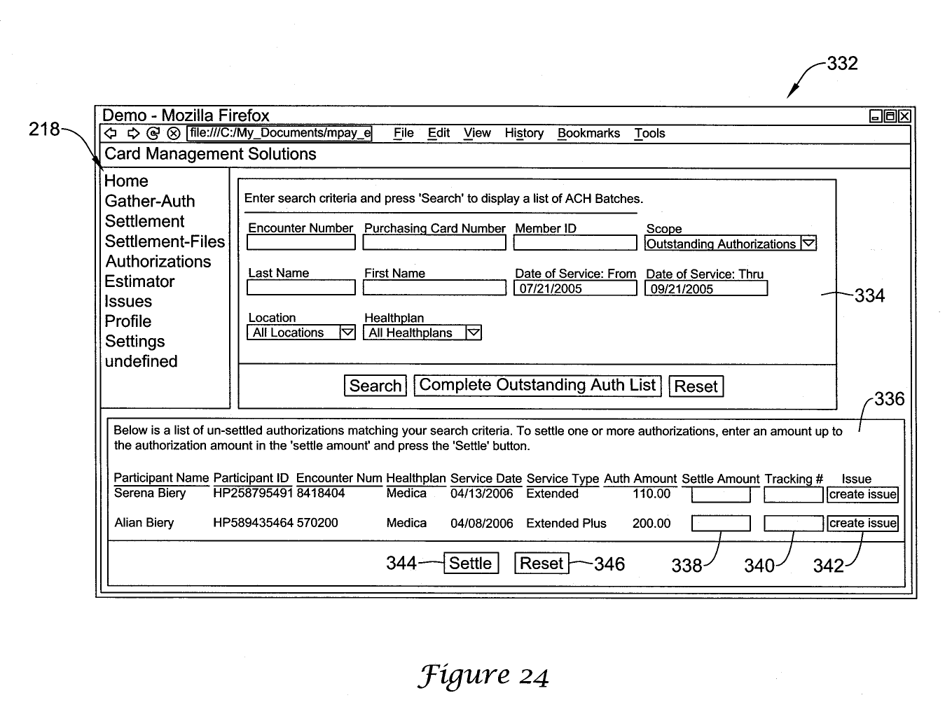

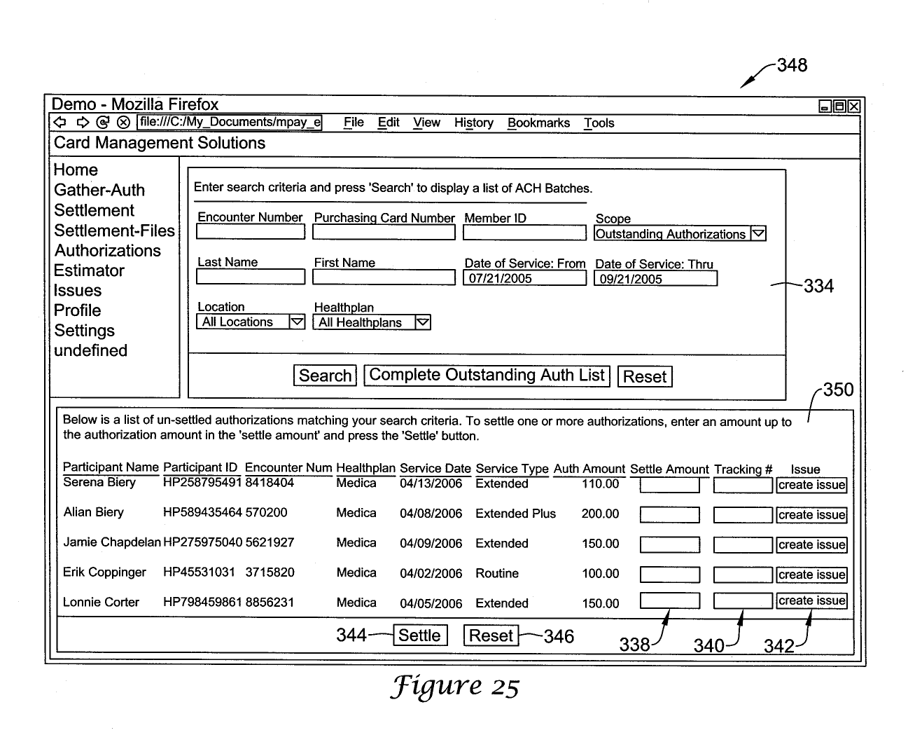

The following Figures show some aspects pertaining to settlement. FIG. 23 shows a screen 320 that may, for example, be reached by clicking on a Settlement link 322 within top level menu 218. Screen 320 includes a text box 324 that permits a user to enter a variety of search criteria. Text box 324 includes a search button 326 that may provide a short list of accounts and their status, as seen in FIG. 24 as well as a complete outstanding auth list button 328 that may provide a longer list of accounts as seen in FIG. 25. A reset button 330 permits the user to remove search criteria and start over, if desired.

Turning now to FIG. 24, the Figure shows a screen 332 that includes a text box 334 and a text box 336. Text box 334 provides a reminder of the search criteria that were used to reach screen 332 while text box 336 provides the search results. It can be seen in text box 336 that there is a settle amount box 338 as well as a tracking number box 340 for each patient listed. If for example information has been received pertaining to a patient's actual financial obligation, this can be entered via settle amount box 338. A tracking number, which may be useful in subsequently tracking or locating a particular transaction or patient, may be manually entered into tracking number box 340. In some instances, system 10 (or system 50) may automatically create the tracking number and thus may automatically populate tracking number box 340.

It can be seen that there is also a create issue button 342 that can be used to flag the transaction, particularly if there is a substantial difference between the estimated financial obligation (and the ensuing electronic authorization) and the actual financial obligation as subsequently reported by the insurance carrier or other payer. Once the settlement information has been entered, the user may click on a settle button 344 to advance the settlement. Otherwise, if an error has been made, the user may click on a reset button 346 to start over.

FIG. 25 provides a screen 348 that may be displayed by system 10 (or system 50) if the user (with reference to FIG. 23) clicked on complete outstanding auth list button 328. Screen 348 includes a text box 350 that provides information pertaining to a larger number of individuals but otherwise includes the same functionality of screen 332 (FIG. 24).

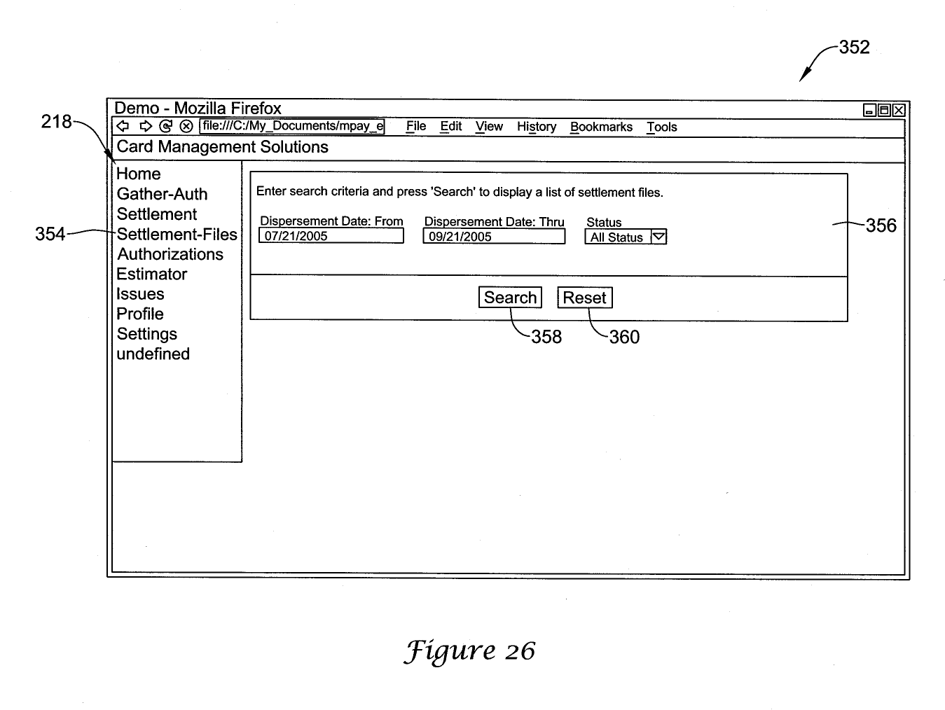

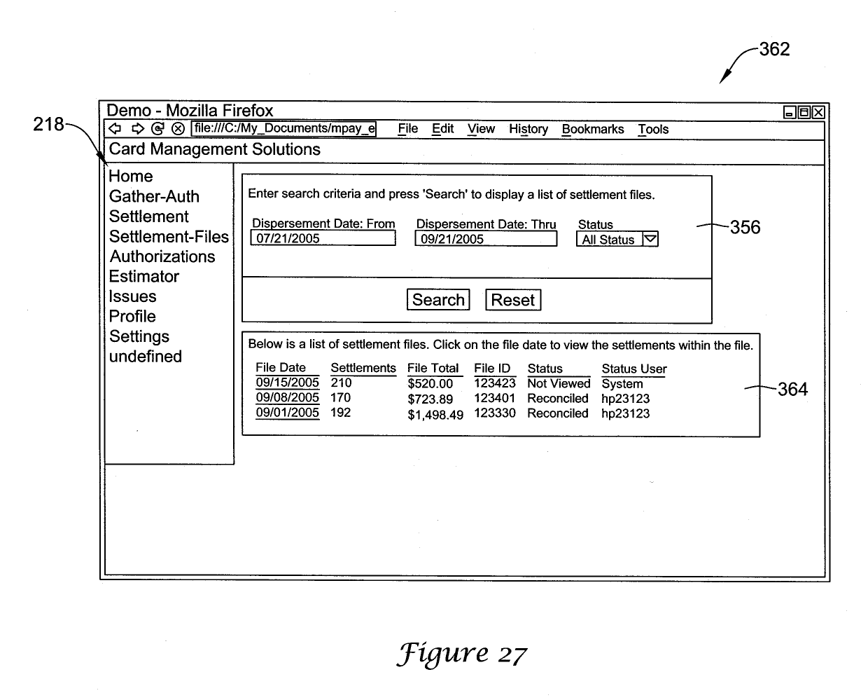

FIG. 26 provides a screen 352 that may be provided by system 10 (or system 50) in response to clicking on a settlement-files link 354 within top level menu 218. Screen 352 includes a text box 356 that permits a user to enter various search criteria. Clicking on a search button 358 begins the search while clicking on a reset button 360 deletes the current search criteria so that the user can start over, if desired. As seen in FIG. 27, a list of settlement files may be displayed within a text box 364 within a screen 362. In some cases, screen 362 may be a new screen that repeats text box 356 (providing the search criteria). In some cases, text box 364 may simply pop up within screen 352 (FIG. 26).

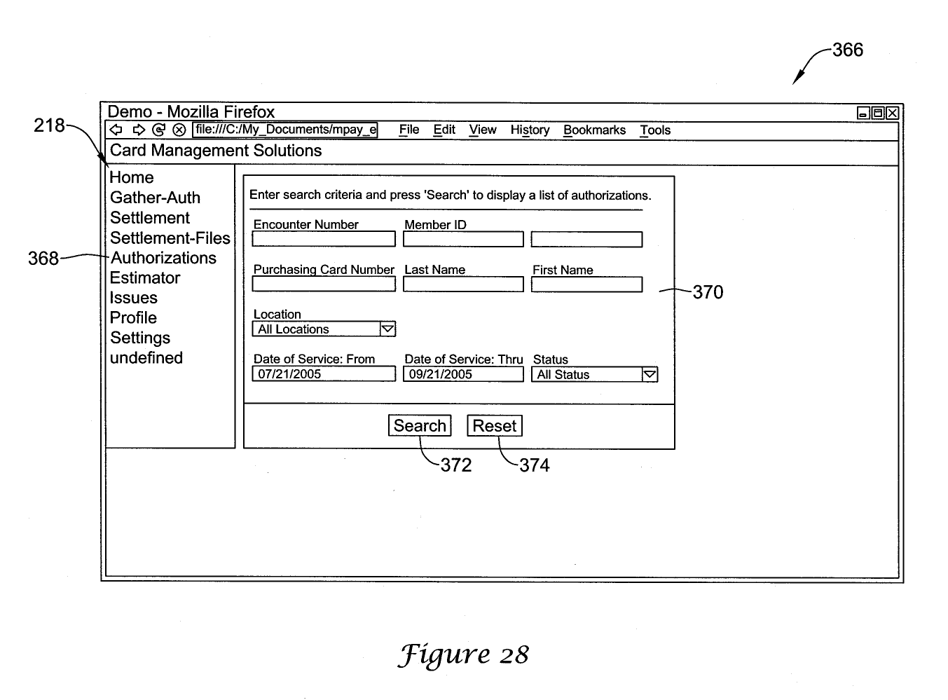

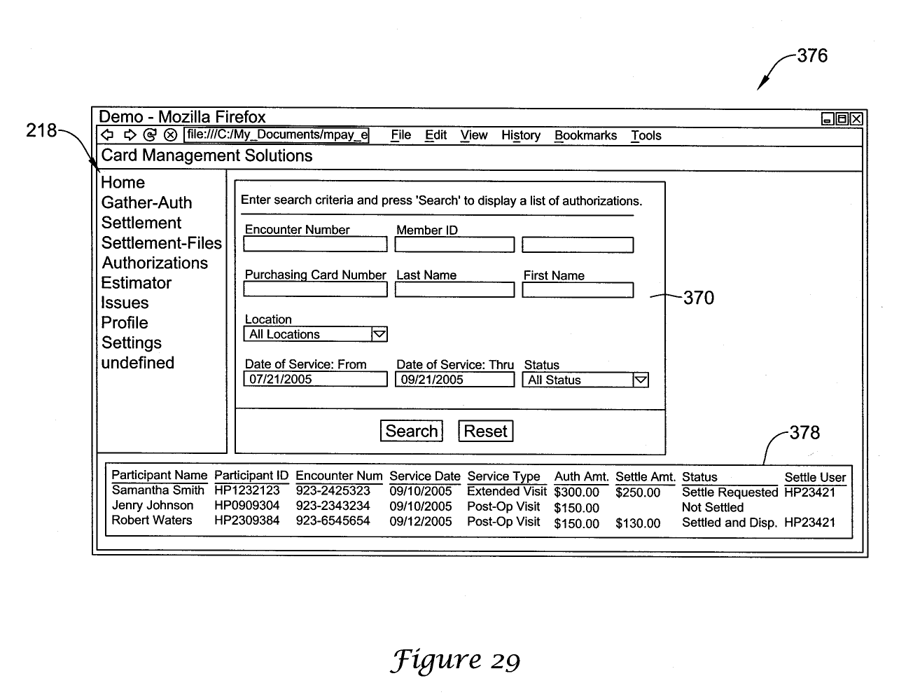

The following Figures show some aspects pertaining to authorization as well as researching transaction history. With reference to FIG. 28, system 10 (or system 50) may display a screen 366 in response to a user clicking on an authorizations link 368 within top level menu 218. Screen 366 includes a text box 370 that may be used to enter a variety of search criteria. A search button 372 initiates a search using the criteria entered by the user while a reset button 374 deletes the search criteria so that the user may start over. Clicking on search button 372 may, given the search criteria shown, cause system 10 (or system 50) to display a screen 376 as seen in FIG. 29. It can be seen that screen 376 includes the text box 370, giving the search criteria, as well as a text box 378 that provides the search results.

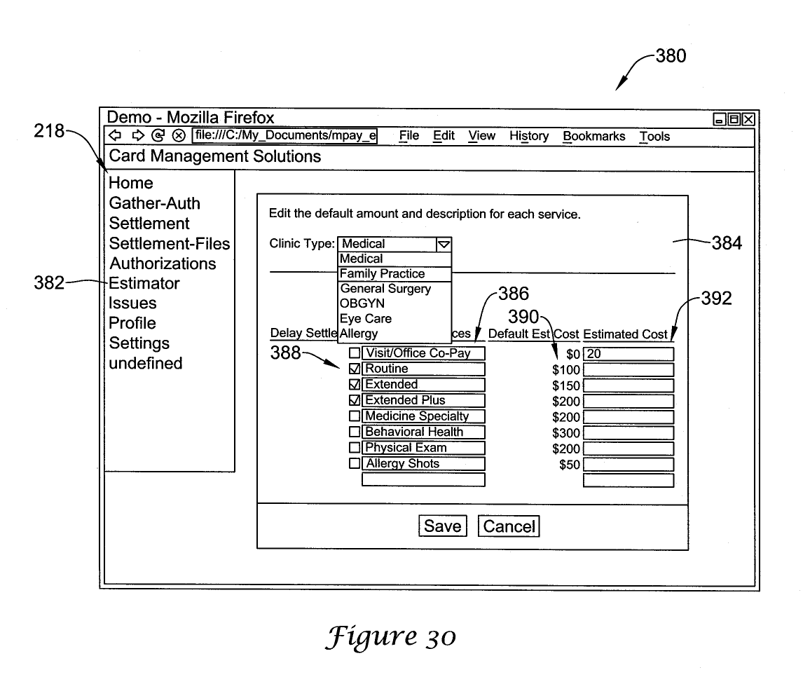

Turning now to FIG. 30, the Figure shows a screen 380 that may be displayed by system 10 (or system 50) in response to the user clicking on an estimator link 382 within top level menu 218. Screen 380 permits a user to program or otherwise enter a variety of different medical procedures, tests and the like that correspond to events that may be included within a patient encounter at a particular health care provider. Screen 380 includes a text box 384 that includes a pull-down menu 386 that permits the user to specify the type of health care provider. In some cases, selecting a particular type of health care provider may alter which procedures, tests and the like are displayed. For example, if the health care provider is a cardiologist they likely do not estimation data pertaining to allergy shots. An allergist does not perform heart surgery.

It can be seen that text box 384 includes a list 386 of estimated services that may be applicable to a particular health care provider. A column 388 of check boxes permit the user to specify, for each listed service, whether the particular service is one that will be paid immediately upon treatment (such as copays and the like), or if there will a delayed settlement. Text box 384 also includes a column 390 of default estimated costs and a column 392 of estimated costs. It is anticipated that there may be situations in which the user may wish to modify the default estimated costs, and they can do so by entering a revised number into the appropriate box within column 392.

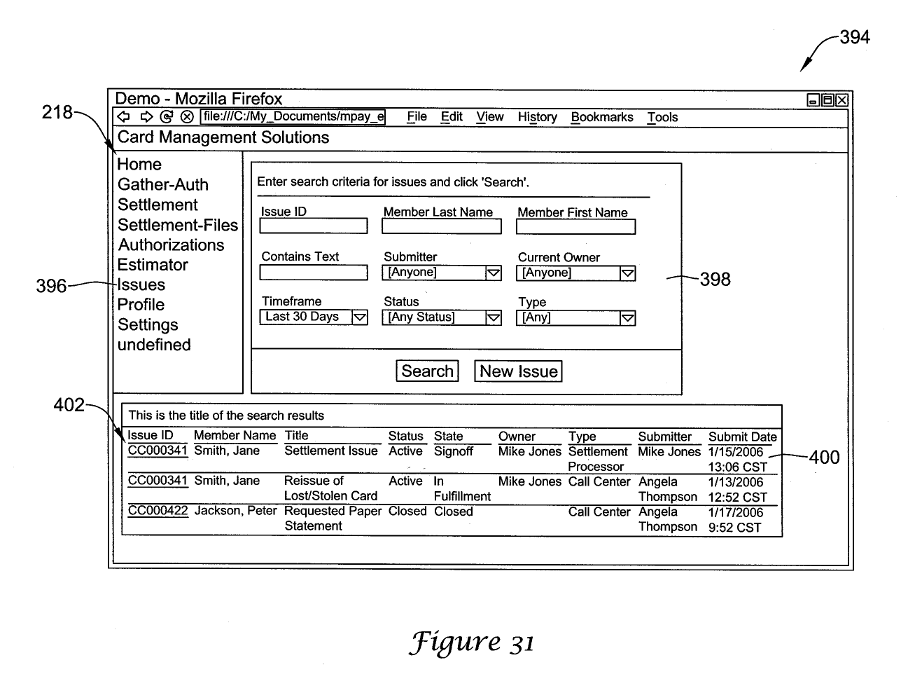

FIG. 31 provides a screen 394 that may be reached by clicking on an issues link 396 within top level menu 218. In some instances, a transaction may be flagged as an issue if there appears to be an error in either the estimated financial obligation or in the actual financial obligation provided by the insurance carrier or other payer. In some cases, a transaction may be flagged as an issue if there is no apparent error in either the estimated or actual financial obligations, but there is a discrepancy between the two or between the actual financial obligation and the electronic authorization previously obtained.

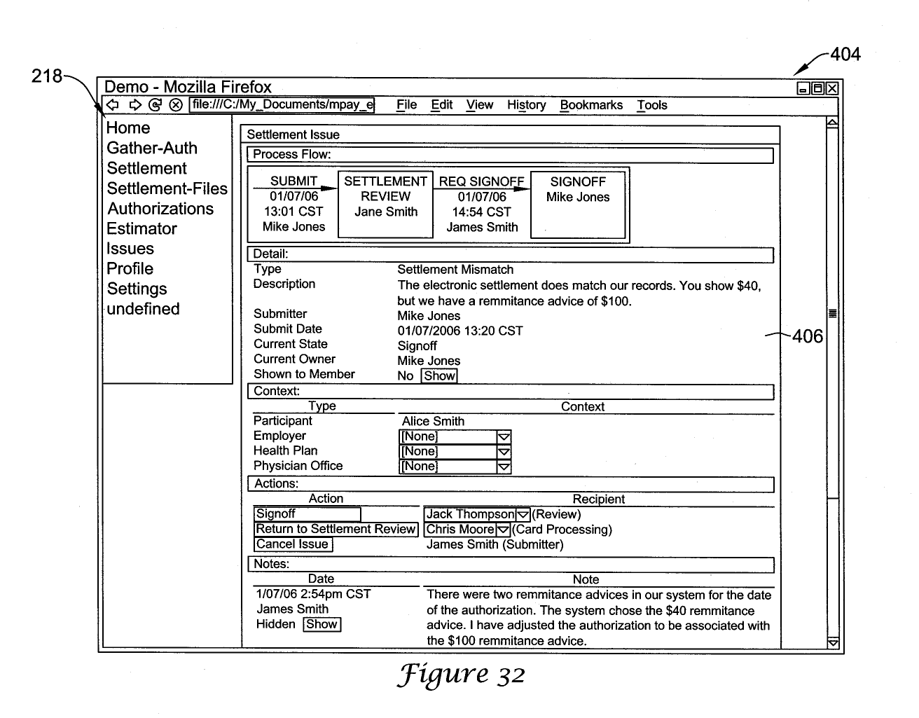

Screen 394 includes a text box 398 that permits the user to select their search criteria. In the given example, they have chosen to search for issues within the last 30 days. A text box 400 displays the search results. In this particular example, it can be seen that there have been 3 issues flagged within the past 30 days. Additional information can be obtained by clicking on an issue ID link 402 displayed within the search results. FIG. 32 is an example of a screen 404 that may be displayed by system 10 (or system 50).

In FIG. 32, screen 404 includes a text box 406 that provides significant information pertaining to this particular issue. In this example, multiple remittance advice values, or actual financial obligation values, have either been received from the insurance carrier or other payer, or for some reason multiple numbers have been entered into the system. In this case, as shown, the issue was resolved by adjusting the authorization to the higher of the two remittance values.

It will be appreciated that the foregoing screen captures are illustrative only, and are not intended to be limiting in any fashion. It will be appreciated that the information provided to (and by) system 10 and system 50 may be displayed in a variety of manners, using a variety of different display technologies, formatting and the like.

Those skilled in the art will recognize that the invention may be manifested in a variety of forms other than the specific embodiments described and contemplated herein. Accordingly, departure in form and detail may be made without departing from the scope and spirit of the invention as described in the appended claims.

What is claimed:

1. A system for obtaining point-of-sale authorization for a delayed settlement, the system comprising: a controller; an identification module implemented by the controller, the identification module configured to accept data pertaining to a patient; an estimation module implemented by the controller, the estimation module configured to obtain an estimate of a financial obligation resulting from a medical encounter with the patient; an authorization module implemented by the controller, the authorization module configured to accept an electronic authorization for payment of an amount that is based on the estimated financial obligation; an output module implemented by the controller, the output module configured to output information pertaining to the medical encounter; an input module implemented by the controller, the input module configured to receive information pertaining to an actual financial obligation; and a settlement module implemented by the controller, the settlement module configured to settle the actual financial obligation via the previously obtained electronic authorization.
